(19) United States
(12) Patent Application Publication
(10) Pub. No.: US 2016/0092088 A1
(43) Pub. Date: Mar. 31, 2016

(54) COMPUTING SYSTEM FACILITATING INTER-USER COMMUNICATION

(71) Applicant: Microsoft Corporation, Redmond, WA (US)

(72) Inventors: John Doyle, Seattle, WA (US); Jay Kapur, Redmond, WA (US); Hansen Liou, Bellevue, WA (US); Jorge Lopez De Luna, Seattle, WA (US); Randy Santossio, Bellevue, WA (US); Steven Trombetta, Seattle, WA (US)

(21) Appl. No.: 14/503,144

(22) Filed: Sep. 30, 2014

(51) Int. Cl. G06F 3/0484; H04L 29/08

(52) U.S. Cl. CPC G06F 3/04847; G06F 3/04842; H04L 67/306

(57) ABSTRACT

Techniques and constructs can provide user communication with reduced bandwidth load. An indication of an item of user-linked content can be received. A confirmation view can be displayed and a confirmation received. An available one of a predetermined number of content slots can be determined. An association between the item of user-linked content and the available content slot can then be recorded in a computer storage medium. An example apparatus can include an insertion module responsive to a user-operable input device to insert a user-linked content item corresponding to a visual representation into one of the content slots. An example apparatus can include a summary module configured to present a summary visual representation of a plurality of items of user-linked content via the display. At least one of the items can include a gameplay video or an in-game collateral item.

### BACKGROUND

Multi-user computing systems often provide information about users of the system to other users of the system. Review of such information is a routine activity for many people. The information provided is frequently determined by the operator of the computer system and is of the same type for all users (e.g., username, real name, and whether the user is logged in). This pre-determination can reduce the usefulness of user information. Users often are forced to consult sources other than the multi-user system itself for information about users of the system.

### SUMMARY

This disclosure describes systems, methods, user interfaces, and computer-readable media for updating, transmitting, retrieving, and displaying user information, e.g., customized user profile information on any of a number of platforms, computing devices, mobile devices, and/or gaming consoles. In at least one example, user profile information can include user-linked content and an association between the user-linked content and an available content slot can then be recorded in a computer storage medium. An example apparatus can include an insertion module responsive to a user-operable input device to insert a user-linked content item corresponding to a visual representation into one of the content slots. An example apparatus can include a summary module configured to present a summary visual representation of a plurality of items of user-linked content via the display.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment for implementing inter-user communication in a multi-user system as described herein.

FIGS. 2-5 show graphical representations of example showcase displays in a multi-user system.

FIG. 6 is a graphical representation of an example profile display in a multi-user system.

FIG. 7 shows a graphical representation of an example showcase display in a multi-user system.

FIG. 8 shows a graphical representation of an example gaming-system display in a multi-user gaming system.

FIG. 9 shows a graphical representation of an example destination-selection user interface.

FIG. 10 shows a graphical representation of an example confirmation view.

FIG. 11 is a block diagram that illustrates an example technique for communicating information between users of a multi-user system.

FIGS. 12 and 13 are flow diagrams that illustrate example processes for updating user information of a user of a multi-user system.

FIG. 14 is a block diagram depicting an example computing device configured to participate in user-profile updating according to various examples described herein.

FIG. 15 is a block diagram depicting an example computing device configured to participate in user-profile retrieving according to various examples described herein.

### DETAILED DESCRIPTION

### Overview

Examples described herein provide techniques and constructs to improve communication between users of multi-user computing systems by providing user control of shared information with reduced bandwidth requirements using resources including, for example, processing units. Such resources may be implemented using specialized programming and/or hardware programmed with specific instructions to implement the specified functions. For example, resources may have different execution models as is the case for graphics processing units (GPUs) and central processing unit (CPUs). Resources configured for such communications can provide improved sharing of user-pertinent information within limits of available network bandwidth, and can reduce the need for users to consult off-system resources for information about each other. Various aspects can provide a user increased control of the personal information shared by that user, which can reduce concerns about privacy of information and increase a user's sense of ownership of that user's user-information repository (“profile”) or the presentation thereof (“profile display”). This can provide increased user satisfaction with the multi-user system.

Some prior schemes limit the information a user can provide to other users to only system-defined information or types of information, as noted above. Other prior schemes provide extensive, detailed information about each user. These schemes can require large storage devices accessible by the multi-user system to store the detailed information and can require high network bandwidth to transmit that information to users. Moreover, some prior schemes require significant storage and bandwidth even to provide users with the opportunity to modify their profiles.

In various examples, algorithms for updating and retrieving profile information as described herein can permit users to share relevant information about themselves with other users, without the computational, bandwidth, or storage burdens of some prior schemes. Some algorithms herein define, maintain, and transmit a showcase as part of the profile information of a user. A user's “showcase” can include one or more items of that user's user-linked content. User-linked content of a particular user can include content connected to or originated by that user, as described in more detail below. In various examples, algorithms for updating or retrieving user-linked content selections as described herein can be performed on a computing device, such as a smart phone, a tablet, a desktop computer, etc., having one or more user-operable input devices, such as a physical keyboard, a soft keyboard, a touch screen, a touch pad, microphone(s), camera(s), etc. to provide improved communication of information between users, e.g., via a user's profile display.

Examples are presented in greater detail in the description of the following figures. Throughout this disclosure, example users are referred to without limitation as, e.g., “Alice,” “Bob,” “BloomquistHarpr,” or “xblsocial034” (“xb” for short). Moreover, the genders of pronouns used in reference to the example users are not limiting.

### Illustrative Environment

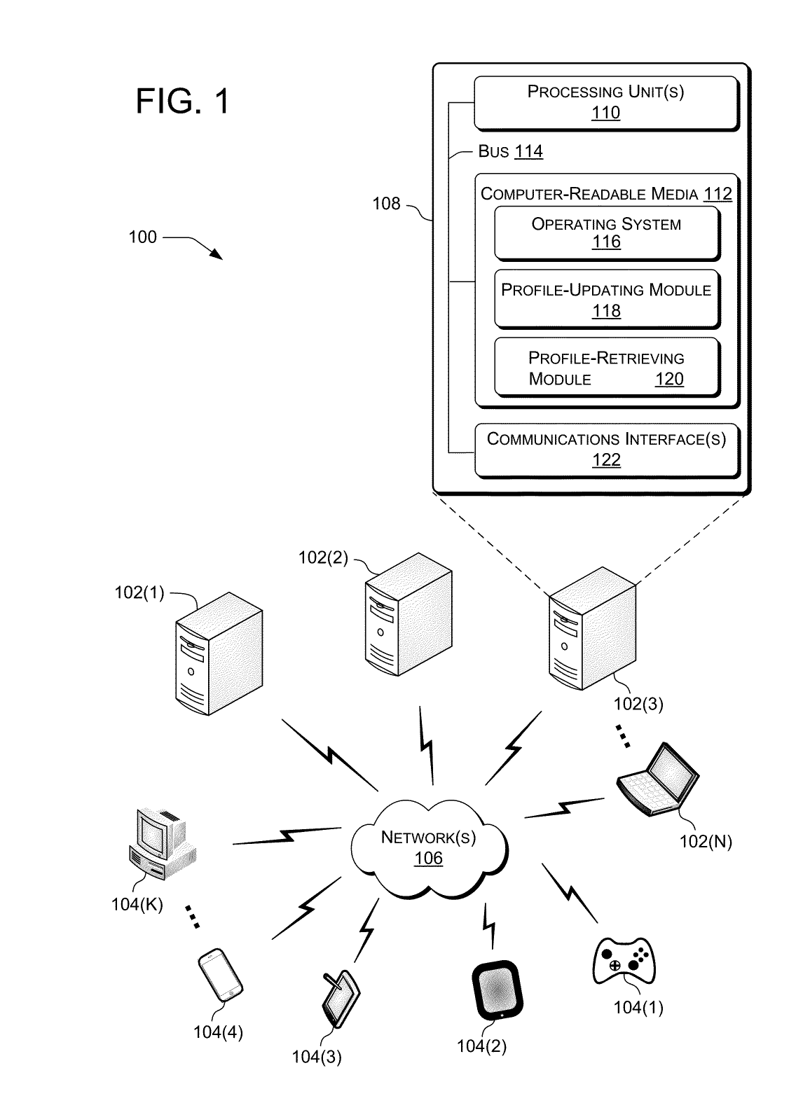

FIG. 1 shows an example environment 100 in which examples of multi-user systems can operate or in which inter-user communication techniques, e.g., profile-editing or -retrieving methods, as described herein can be performed. In some examples, the various devices and/or components of environment 100 include computing device(s) 102(1)-102(N), N≧1 (individually or collectively referred to herein with reference 102) and computing devices 104(1)-104(K), K≧1 (individually or collectively referred to herein with reference 104). In an example of a multi-user system, computing devices 102 are servers and computing devices 104 are clients. Computing devices 102 and/or 104 can communicate with one another via one or more network(s) 106. In some examples, N=K; in other examples, N>K or N<K. In some examples, computing devices 102 and 104 can communicate with devices outside the multi-user system via network(s) 106.

For example, network(s) 106 can include public networks such as the Internet, private networks such as an institutional or personal intranet, or some combination of private and public networks. Network(s) 106 can also include any type of wired or wireless network, including but not limited to local area networks (LANs), wide area networks (WANs), satellite networks, cable networks, Wi-Fi networks, WiMAX networks, mobile communications networks (e.g., 3G, 4G, and so forth) or any combination thereof. Network(s) 106 can utilize communications protocols, including packet-based or datagram-based protocols such as internet protocol (IP), transmission control protocol (TCP), user datagram protocol (UDP), other types of protocols, or combinations thereof. Moreover, network(s) 106 can also include a number of devices that facilitate network communications or form a hardware basis for the networks, such as switches, routers, gateways, access points, firewalls, base stations, repeaters, backbone devices, and the like. Network(s) 106 can also include devices that facilitate communications between computing devices 102 and/or 104 using bus protocols of various topologies, e.g., crossbar switches, INFINIBAND switches, or FIBRE CHANNEL switches or hubs.

In some examples, network(s) 106 can further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), other standards, e.g., BLUETOOTH, or multiples or combinations thereof.

In various examples, at least some of computing devices 102(1)-102(N) or 104(1)-104(K) can operate in a cluster or grouped configuration to, e.g., share resources, balance load, increase performance, or provide fail-over support or redundancy. Computing device(s) 102 and/or 104 can belong to a variety of categories or classes of devices such as stationary-type devices, mobile-type devices, special purpose-type devices, etc. Thus, although illustrated as, e.g., desktop computers, laptop computers, tablet computers, or cellular phones, computing device(s) 102 and/or 104 can include a diverse variety of device types and are not limited to a particular type of device. In some examples, stationary-type computing device(s) 102 can include, but are not limited to, desktop computers, server computers, web-server computers, and server blades, such as those capable of storing or communicating information of a multi-user system, for example servers hosting a multi-user system. Example computing device(s) 102 can include servers or high-performance computers configured to receive, store, and transmit user profile information such as showcase information.

In some examples, computing device(s) 104 can include computing devices configured to communicate with computing device(s) 102 of a multi-user system or with other computing device(s) 104 of the multi-user system, e.g., to update, retrieve, or display a user's profile as described herein. Various example computing device(s) 104 are configured to update, retrieve or display showcase information. In some examples, computing device(s) 104, such as 104(1) (represented graphically as a gamepad) include special purpose-type devices and can include entertainment devices such as gaming consoles or devices, arcade-game machines, media players, personal video recorders (PVRs), network-connectable cameras, etc. In some examples, special purpose-type devices can include computer navigation type client computing devices, satellite-based navigation system devices including global positioning system (GPS) devices and other satellite-based navigation system devices, integrated components for inclusion in a computing device, etc.

In some examples, computing device(s) 104 can include mobile-type devices, such as tablet computers 104(2), wearable computers, implanted computing devices, telecommunication devices, mobile phone-tablet hybrid devices, personal data assistants (PDAs) 104(3), telecommunication devices 104(4) such as mobile feature phones, smartphones, etc. (e.g., phones or phone/tablet hybrids running a WINDOWS PHONE operating system, an ANDROID operating system, an IOS operating system, etc.). In some examples, computing device(s) 104, such as 104(K), can include devices generally larger than a clothing pocket, which can be stationary type-devices such as, for example, personal computers, thin clients, terminals, network enabled televisions, set-top boxes, appliances, or mobile-type devices such as laptop computers, automotive computers, mobile computers, or work stations.

In an example of a multi-user gaming system, computing device(s) 102 can be servers and computing device 104(1) can be a gaming console such as a MICROSOFT XBOX, MICROSOFT XBOX 360, MICROSOFT XBOX ONE, SONY PLAYSTATION, NINTENDO WII, etc. Computing devices 104(2), 104(3), 104(4) can be a tablet, a PDA, and a smartphone, respectively. Any of computing devices 104(2)-(4) can run a program (“app”) configured to interface or interact with the multi-user system, e.g., MICROSOFT SMARTGLASS, the NETFLIX app, the STEAM app, etc. Computing device 104(K) can be a personal computer (e.g., a desktop or laptop) including Web browser software to access a Web site of or associated with the multi-user system such as a social network and/or gaming network, e.g., FACEBOOK, TWITTER, etc. and/or the MICROSOFT Web site “XBOX.COM,” the SONY Web site “PlayStation.com,” the NINTENDO Web site “NINTENDO.COM,” etc., associated with the XBOX LIVE, the SONY PLAYSTATION NETWORK, the NINTENDO NETWORK, etc. Computing device 104(K) can also include gaming software, e.g., the STEAM software platform and gaming network from VALVE and game(s) associated with the STEAM system.

Computing device(s) 102 and/or 104 can include various components illustrated at inset 108. Computing device(s) 102 and/or 104 can include any computing device having one or more processing unit(s) 110 operably connected to one or more computer-readable media 112 such as via a bus 114, which in some instances can include one or more of a system bus, a data bus, an address bus, a PCI bus, a Mini-PCI bus, and any variety of local, peripheral, or independent buses, or any combination thereof. In at least one example, plural processing units 110 may exchange data through an internal interface bus (e.g. PCIe), rather than or in addition to network 106.

Processing unit(s) 110 can be or include one or more single-core processors, multi-core processors, central processing units (CPUs), graphics processing units (GPUs), general-purpose graphics processing units (GPGPUs), or hardware logic components configured, e.g., via programming from modules or APIs, to perform functions described herein. For example, and without limitation, illustrative types of hardware logic components that can be used in or as processing units 110 include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and Digital Signal Processors (DSPs). For example, a processing unit 110 can represent a hybrid device, such as one from ALTERA or XILINX that includes a CPU core embedded in an FPGA fabric. These or other hardware logic components can operate independently or, in some instances, can be driven by a CPU. In various examples, at least some of computing device(s) 102(1)-102(N) can include a plurality of processing units 110 of multiple types. For example, the processing units 110 in computing device 102(1) may be a combination of one or more GPGPUs and one or more FPGAs.

Executable instructions stored on computer-readable media 112 can include, for example, an operating system 116, a profile-updating module 118, a profile-retrieving module 120, and other modules, programs, or applications that are loadable and executable by processing unit(s) 110. The processing unit(s) 110 may be configured to execute the operating system 116 or other code stored on the computer-readable media 112.

In an example not shown, one or more of the processing unit(s) 110 in one of the computing device(s) 102 and/or 104 can be operably connected to computer-readable media 112 in a different one of the computing device(s) 102 and/or 104, e.g., via communications interface(s) 122 and network(s) 106. For example, program code to perform profile-updating or profile-querying steps herein can be downloaded from a server, e.g., computing device 102(1), to a client, e.g., computing device 104(K), e.g., via the network 106, and executed by one or more processing unit(s) 110 in computing device 104(K). In an example, computing device(s) 102(1)-102(N) include profile-storage module(s) (not shown), and computing device(s) 104(1)-104(K) include profile-updating module 118 or profile-retrieving module 120.

Computing device 102 can also include one or more communications interfaces 122 to enable wired or wireless communications between one of the computing device(s) 102 and other networked computing device(s) 102 and/or 104 involved in the multi-user system, or other computing device(s), over network(s) 106 or other communication links or channels. Such communications interface(s) 122 can include one or more transceiver devices, e.g., network interface controllers (NICs) such as Ethernet NICs or other types of transceiver devices to send and receive communications over a network. The processing units 110 may exchange data through the communications interface 122. In an example, the communications interface 122 may be a Peripheral Component Interconnect Express (PCIe) transceiver, and the network 106 can be a PCIe bus. In some examples, the communications interface 122 can include, but is not limited to, a transceiver for cellular, Wi-Fi, Ultra-wideband (UWB), BLUETOOTH, or satellite transmissions. The communications interface 122 can include a wired I/O interface, such as an Ethernet interface, a serial interface, a Universal Serial Bus (USB) interface, an INFINIBAND interface, or other wired interfaces. For simplicity, these and other components are omitted from the illustrated computing device 102.

While the processing units 110 are described as residing on the computing device 102 and connected by the communications interface 122 in various examples, the processing units 110 may also reside on different computing devices in some examples. In some examples, the processing units 110 may reside on corresponding computing devices 102, and may exchange data through a network 106 via communications interface 122. In some examples, at least two of the processing units 110 may reside on different computing devices 102. In such examples, multiple processing units 110 on the same computing device 102 may use a bus 114 of the computing device 102 to exchange data, while processing units 110 on different computing devices 102 may exchange data via network(s) 106.

Computer-readable media described herein, e.g., computer-readable media 112, may include computer storage media and/or communication media. Computer storage media can include tangible storage units such as volatile memory, nonvolatile memory, and/or other persistent and/or auxiliary computer storage media, removable and non-removable computer storage media implemented in any method or technology for storage of information such as computer-readable instructions, data structures, program modules, or other data. Computer-readable media 112 can be an example of computer storage media or communications media. Thus, computer storage media can include tangible or physical forms of media included in a device or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media.

In some examples, computer-readable media 112 can store instructions executable by the processing unit(s) 110 that, as discussed above, can represent a processing unit incorporated in computing device 102. Computer-readable media 112 can also store instructions executable by external processing units such as by an external CPU or external processor of any type discussed above. In various examples at least one processing unit 110, e.g., a CPU, GPU, or FPGA, is incorporated in computing device 102, while in some examples at least one processing unit 110, e.g., one or more of a CPU, GPU, or FPGA, is external to computing device 102.

Computer-readable media 112 of the computing device 102 may store an operating system 116. In some examples, operating system 116 is not used (commonly referred to as a “bare metal” configuration). In some examples, operating system 116 is stored in a nonvolatile memory of the computer-readable media 112, e.g., a flash memory. In various examples, operating system 116 may include components that enable or direct the computing device 102 to receive data via various inputs (e.g., user controls, network or communications interfaces, or memory devices), and to process the data using the processing unit(s) 110 to generate output. The operating system 116 may further include one or more components that present the output (e.g., display an image on an electronic display, store data in memory, transmit data to another electronic device, etc.). In an example, computing device 104(1) is a gaming system and the operating system directs computing device 104(1) to receive joystick, gamepad, motion-sensor, or imager data, to provide that data to game or demo software, to receive data of game or demo output, and to provide visual, audible, or haptic representations of the game output data (e.g., screens, music). The operating system 116 can enable a user to interact with modules of the profile-updating module 118 or the profile-retrieving module 120 using a user interface (not shown in FIG. 1). Additionally, the operating system 116 can include components that perform various functions generally associated with an operating system, e.g., storage management and internal-device management.

### Illustrative User Interface Components

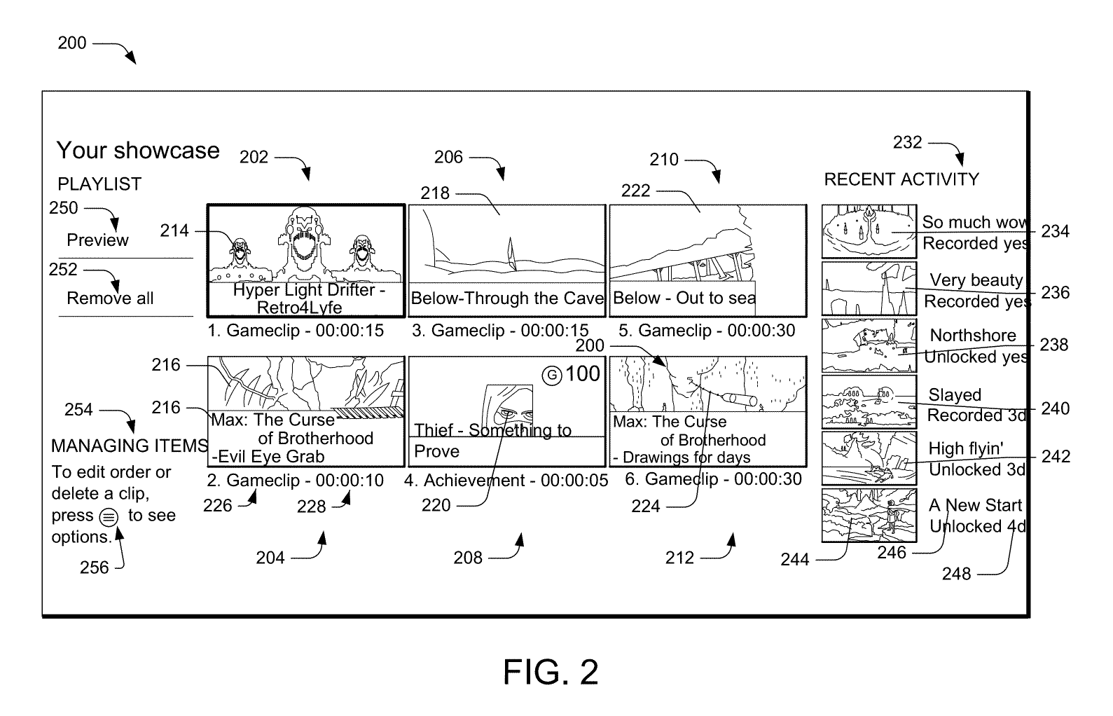

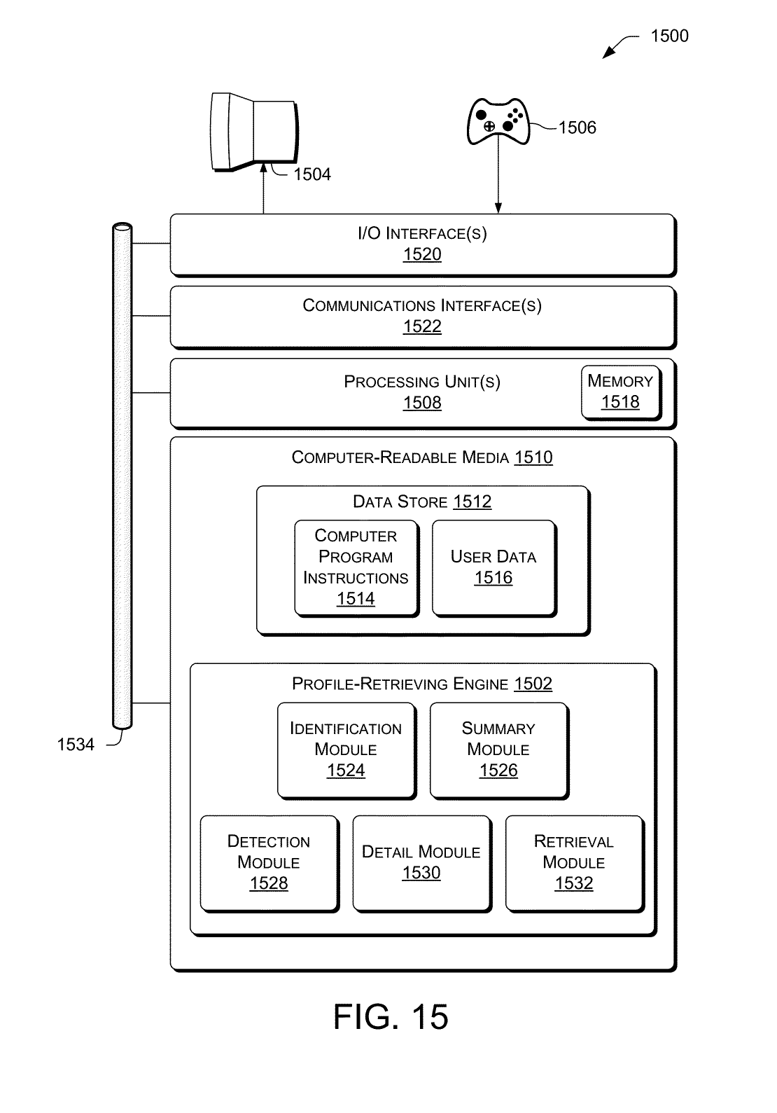

FIG. 2 shows a graphical representation of an example showcase display 200 for a user of a multi-user system. In this example, the multi-user system is a gaming system. The example showcase display 200 includes six content slots 202, 204, 206, 208, 210, 212. Each content slot 202-212 in this example is associated with an item of user-linked content. Content slots can be empty, i.e., not associated with any content. The content slots are referred to herein collectively as a “showcase.” The showcase display 200 shows, for each content slot 202-212 in the showcase, a respective summary visual representation 214, 216, 218, 220, 222, 224 of the associated user-linked content. In this example, the summary visual representations 214-224 represent still (non-moving) thumbnails. In some examples, at least some of the summary visual representations 214-224 can include video clips, e.g., as discussed below with reference to FIG. 15.

“User-linked content” is content representable in the multi-user system that is created by, or originates or derives from the actions of, a particular user. Each user of a multi-user system can have a respective, different collection of user-linked content items. User-linked content items can be provided by or using any computing device connected to the multi-user system, whether or not any particular computing device is in communication with the multi-user system at the time the user-linked content item is created or derived. For example, in-game or in-program achievements, discussed below, can be earned by a user while playing an electronic game or using non-game software and connected to a multi-user system or when playing an electronic game or using non-game software offline (not connected to the multi-user system). For user-linked content created or derived while the user is offline, a data record of the achievement can be stored on the user's gaming system or other terminal and then transmitted to the multi-user system when the user's terminal next connects to the multi-user system.

An item of user-linked content created by a user (“user-created content”) can include, for example, one or more of the following: videos, text items, photos, and/or combinations thereof, which can include gameplay videos (including gameplay screenshots), user-provided text messages such as location information and user-provided biographical information, and/or user-provided messages such as those created via a message control. Throughout this disclosure, “text” is not limited to any particular language or character set, but can include, e.g., letters, ideographs, ideograms, symbols used in syllabaries, numbers, punctuation, and/or emoticons (“smileys”). Gameplay videos and screenshots are user-created insofar as the specific portion(s) of the gameplay to be captured are selected by the user, and the video(s) or screenshot(s) can represent in-game activity controlled by the user. Further examples of user-created content can include user designations of “favorites” or “followed” items such as games or other items representable by the multi-user system, except for other users. In an example, a designation that Alice is Bob's best friend is not an example of Bob's user-created content, but a designation that Bob's favorite game is HYPER LIGHT DRIFTER can be an example of Bob's user-created content. An example of user-created content is a message sent by a user in a chat forum, e.g., an Internet Relay Chat (IRC) channel. An example of user-created content is a message provided by the multi-user system or software thereof in response to a change by a user of that user's identification or profile information, e.g., in response to a change of location information or user-provided biographical information.

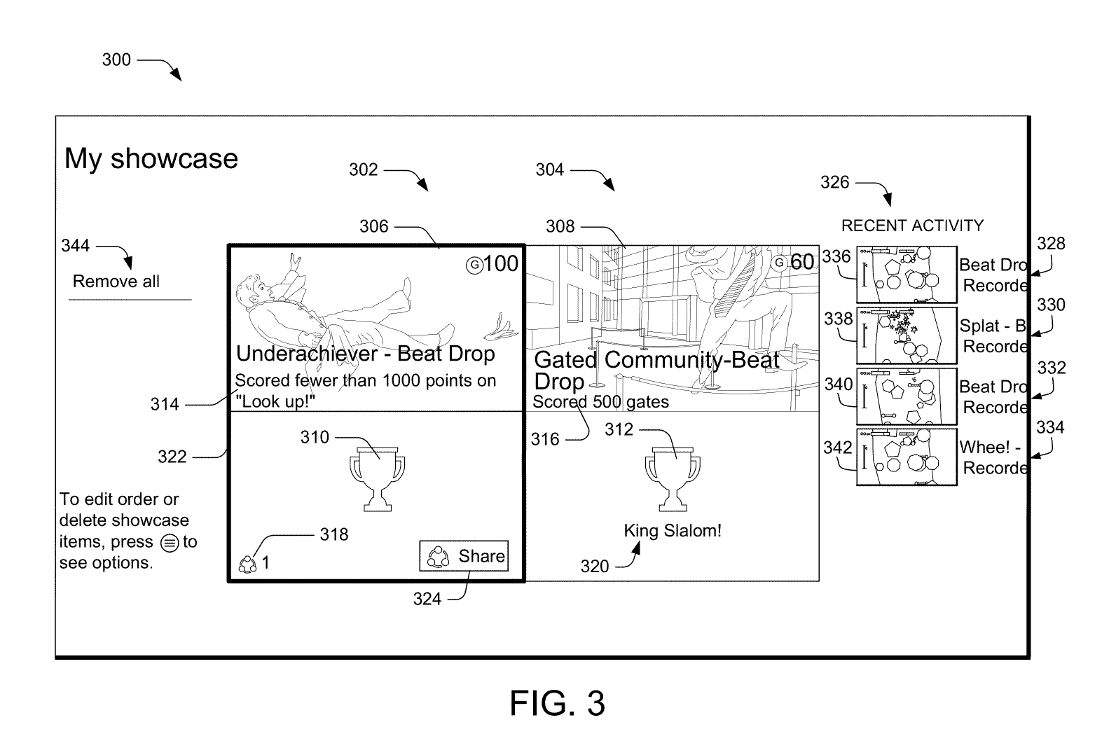

An item of user-linked content originating or deriving from the actions of a particular user (“user-earned content”) can include one or more of the following: user “achievements,” “trophies,” or other awards, i.e., data records indicating that a user has satisfied a particular set of conditions or performed a particular set of tasks on the multi-user system or using software associated with the multi-user system. For example, as discussed below with reference to FIG. 3, the illustrated user-linked content item in content slot 302 is an achievement for the game “BEAT DROP.” The user does not originate the achievement, but instead earns or qualifies for the achievement by performing specific actions, in the illustrated example scoring “fewer than 1000 points on ‘Look up!’” Similarly, operating systems, productivity applications (e.g., word processors), or other software integrated or communicating with the multi-user system can provide achievements or awards as user-earned content. Examples of such other software can include integrated development environments used for programming or other software-development tasks. In an example, a user-earned content item for the MICROSOFT VISUAL STUDIO programming environment can be an “Interrupting Cow” badge (5 points), earned by setting ten breakpoints in a single file. In an example, a user-earned content item can be an achievement earned, e.g., by watching a predetermined number of videos using a video app, such as a NETFLIX or AMAZON VIDEO app, running on a computing device 104.

An item of user-earned content can include one or more of the following: gameplay statistics of that particular user's gameplay, e.g., percent of a game complete, percent of a current level or game area complete, number of in-game secrets discovered or unlocked, or time spent playing a particular game. User-earned content can include game-specific statistics (e.g., “hero stats”). Various examples of user-earned content can include in-game collateral items. For example, if a user playing a combat game earns, discovers, or purchases a particular rare weapon, a data record indicating that user has that weapon is an item of user-earned content. Various examples of user-earned content can include in-game currency or points. In an example of a multi-user gaming system supporting asynchronous gaming, a user can play a game using a computing device 102 and earn credits. Records of those credits are user-earned content items and can be displayed to other users. Those other users do not receive the points, but instead see a visual representation indicating that the user playing the game has received the points. In at least one example, the points can be redeemed for in-game collateral or other items in a game played on a game console.

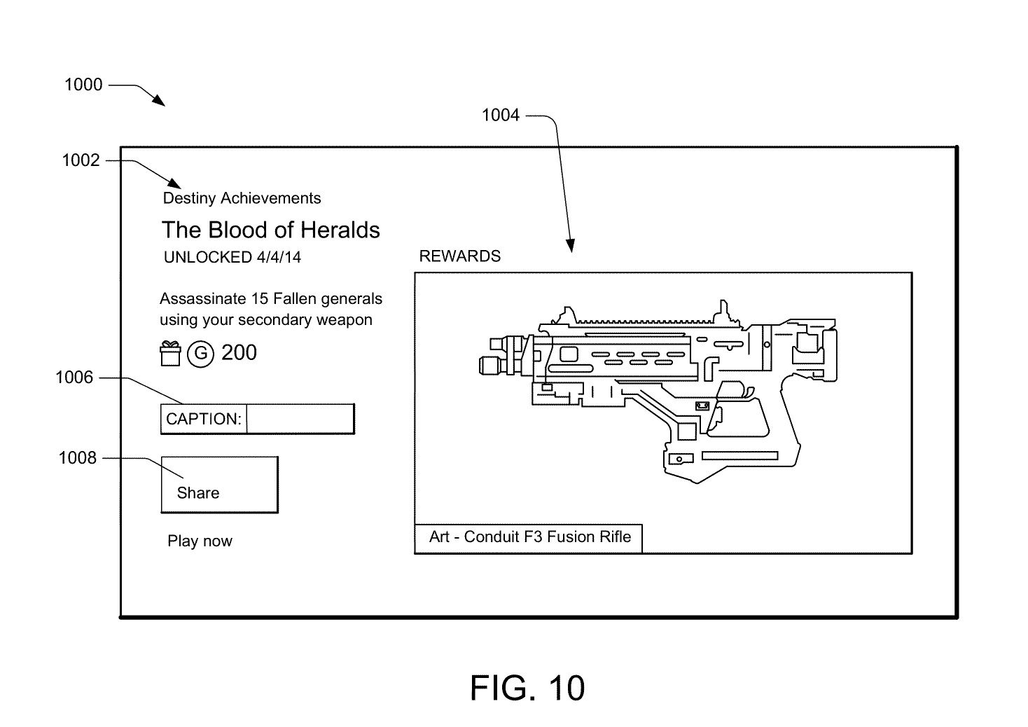

Other examples of user-linked content include aggregations of related user-linked content (“aggregate items”). In an example, an achievement earned by Alice and an in-game collateral item unlocked or provided when Alice earned the achievement can together compose a single aggregate item of user-linked content and occupy a single content slot. In various examples, that achievement and that in-game collateral item are two separate items of user-linked content. Aggregate items can be defined by the multi-user system or software associated with the multi-user system. For example, games can define their own aggregate content items in a multi-user gaming system. Further examples are discussed below with reference to FIG. 10.

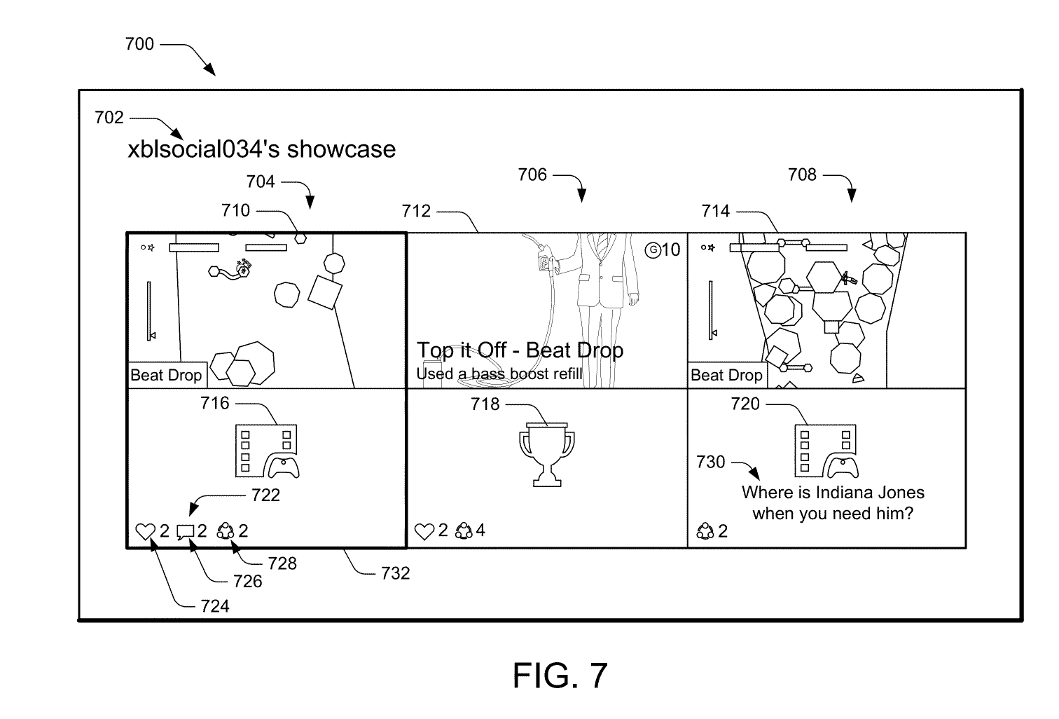

The example showcase display 200 also shows supplemental information of the items of user-linked content in the content slots 202-212. In the illustrated example, the supplemental information includes, for each of the content slots 202-212, a respective type indicator (e.g., “Gameclip,” signifying a gameplay video) and a respective content size indicator (e.g., length of a gameplay video). For clarity, only type indicator 226 and size indicator 228 are shown, in association with content slot 204. Type indicators are further discussed below with reference to FIGS. 3 and 7. The size indicator 228 can show, e.g., the duration of a video clip, the size in bytes of data of the user-linked content item, or the number of lines or pages of text associated with a user-linked content item. Each of the content slots 202-212 also includes a respective description. For clarity, only description 230 is shown, in association with content slot 204.

The example showcase display 200 also includes user-activity feed 232. User-activity feed 232 is an example of a content-display area and includes respective visual representations 234, 236, 238, 240, 242, 244 of respective items of user-linked content. In the illustrated example, visual representations 234-244 are spaced apart from summary visual representations 214-224. User-activity feed 232 in the illustrated example also includes supplemental information for each of the content items, specifically a caption and a recency message indicating the age of the respective user-linked content item. For clarity, only caption 246 and recency message 248 are shown, in association with visual representation 244. In an example, caption 246 is provided by a user and recency message 248 is provided by the multi-user system or an element or module thereof. User-activity feed 232 can include a description (not shown) provided by the multi-user system or an element or module thereof.

User-activity feed 232 can include the most recent n items, n ε [symbol] >0, of a permanent, unlimited, automatically-updated record of notable uses of the multi-user system by a user. In the example shown, user-activity feed 232 includes gameplay videos recorded by the user. In some examples, user-activity feed 232 does not show user-linked content items already in the showcase (content slots 202-212); on some examples, user-activity feed 232 does show sufficiently recent user-linked content items already in the showcase (content slots 202-212).

The showcase (content slots 202-212) holds a limited number of user-selected uses of the multi-user system, i.e., of user-linked content items. The provision by the multi-user system of a showcase permits users to share information about themselves without imposing the bandwidth and storage load of transferring a possibly years-long user-activity feed to another user.

In the illustrated example, showcase display 200 also includes a preview control 250, a clearing control 252 (“remove all”), and an instructional message 254 or other help or user-assistance message. In the illustrated example, instructional message 254 references (and includes a visual representation 256, “ [symbol] ”, of) a menu button, e.g., on a user-operable input device.

Throughout this disclosure, references to “controls,” “buttons,” or other user-interface elements through which a user provides input to computing device 102 and/or 104 include any of various classes of user-operable input devices unless otherwise explicitly noted. An example of a device class is a hardware-device class, in which a user provides input by mechanically moving tangible components of an electromechanical or optomechanical device. Hardware devices can include devices in which the tangible components have respective, fixed functions (e.g., the lever on a circuit breaker). Hardware devices can also include devices in which the tangible components are associated, visually or otherwise, with electronic labels that indicate the function of the tangible component at any given time. Such components and their associated electronic labels are conventionally referred to as “soft keys.” Soft key devices can include, e.g., feature phones having two menu buttons arranged near an electronic display, in which the electronic display presents text near each of the menu buttons indicating the current action the feature phone will take when the user presses the corresponding button. The two menu buttons in this example are soft keys. An example of a device class is a touchscreen device class, in which a user provides input by contacting a portion of a touch sensor (e.g., resistive, capacitive, or optical) operatively arranged with respect to a visual display to give the impression that an active area on the visual display is a button that can be pressed or a control that can be manipulated. Computing devices 102 and/or 104 can include any combination of controls from any device class. Accordingly, reference herein to “actuating” or “operating” (or similar terms) user-operable input devices, or “buttons,” “controls,” or other elements of user-operable input devices or of computing systems, do not require that the user-operable input device have controls in the hardware-device class.

In an example, when Alice actuates (e.g., selects, clicks, touches) preview control 250, the computing device 104 showing the example showcase display 200 can present the user-linked content items of Alice's showcase, e.g., as they would be viewed in a visual representation by Bob viewing Alice's profile display. When the user actuates clearing control 252, the items of user-linked content are removed from the content slots 202-212. The example instructional message 254 informs a user how to access a rearrangement control or a single-item clearing control (neither shown). In an example, a smartphone app can permit rearranging items, e.g., by dragging and dropping.

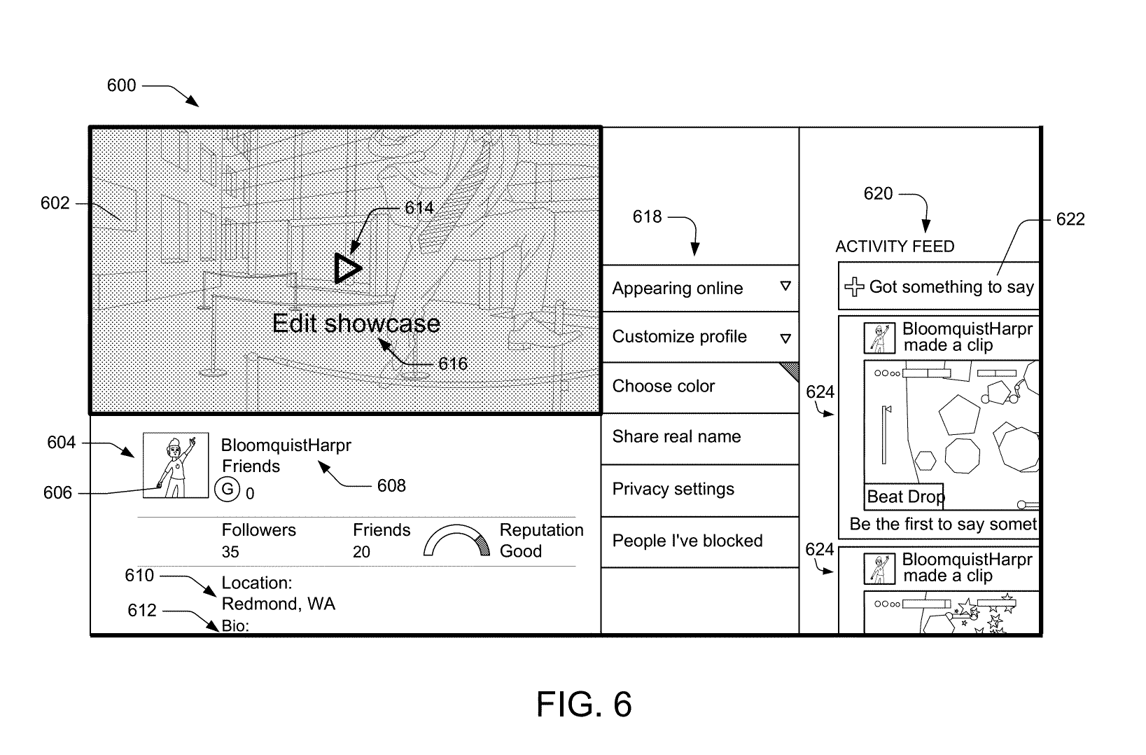

In at least one example, a “pin” control (or “sticky” control, not shown) is provided in association with user-activity feed 232 or one or more of the visual representations 234-244 therein. The example showcase display 200 or an activity-feed display (e.g., activity feed 620, FIG. 6) is responsive to activation of the pin control to lock the corresponding item in the user-activity feed 232 until the pin control or an un-pin control is actuated. In this way, Alice can lock some or all of the contents of Alice's user-activity feed so that Bob will retrieve the locked items when requesting user information (e.g., profile information) for Alice.

FIG. 3 shows a graphical representation of an example showcase display 300 for a user of a multi-user system. In this example, the multi-user system is a gaming system. The example showcase display 300 includes two content slots 302, 304. Each content slot 302, 304 in this example is associated with an item of user-linked content. The showcase display 300 can show, for each content slot 302, 304, a respective summary visual representation 306, 308 of the associated user-linked content or respective supplemental information. Supplemental information can include, for each content slot 302, 304, a respective type indicator 310, 312, a respective description 314, 316, a sharing indicator 318, a respective caption (e.g., caption 320 in content slot 304) or any combination thereof. Showcase display 300 can show, e.g., a selection frame 322 associated with one of the content slots 302, 304. The descriptions 314, 316 can include title and subtitle portions and can be system-generated, user-entered, or a combination. In an example, the descriptions 314, 316 indicate the game name, achievement name, or other information identifying the software to which the respective user-linked content item applies. In various examples, captions such as caption 320 are supplied by the user and can include, e.g., text or images. In the illustrated example, the user has entered “King Slalom!” as text in caption 320 for content slot 304. In various examples, type indicator 312 is hidden if the user as provided a caption 320. In various examples, caption 320 is displayed superimposed on or proximal to type indicator 312. The type indicators 310, 312 in this example are graphical icons of trophies, indicating that the respective user-linked content items are in-game achievements. Further examples of type indicators 310, 312 are discussed below with reference to FIG. 7. In at least one example, content slots 302, 304, or only a highlighted or selected one of 302, 304, in the illustrated example content slot 302, can include a sharing control 324. Sharing control 324 permits sharing of the corresponding item of user-linked content in the corresponding content slot via a communications link.

The example showcase display 300 can include user-activity feed 326, which can represent user-activity feed 232. As noted above, one or more user-linked content item(s) 328, 330, 332, 334 in user-activity feed 326 can be added to an empty one of the content slots 302, 304. Visual representations 336, 338, 340, 342 are presented in user-activity feed 326 in association with respective user-linked content items 328, 330, 332, 334.

The example showcase display 300 can include clearing control 344. Upon actuation of clearing control 344, content slots 302, 304 can be emptied of their associations with user-linked content items. Empty content slots 302, 304 can be displayed as placeholders, e.g., dotted outlines or other placeholders discussed herein, or can be omitted from showcase display 300.

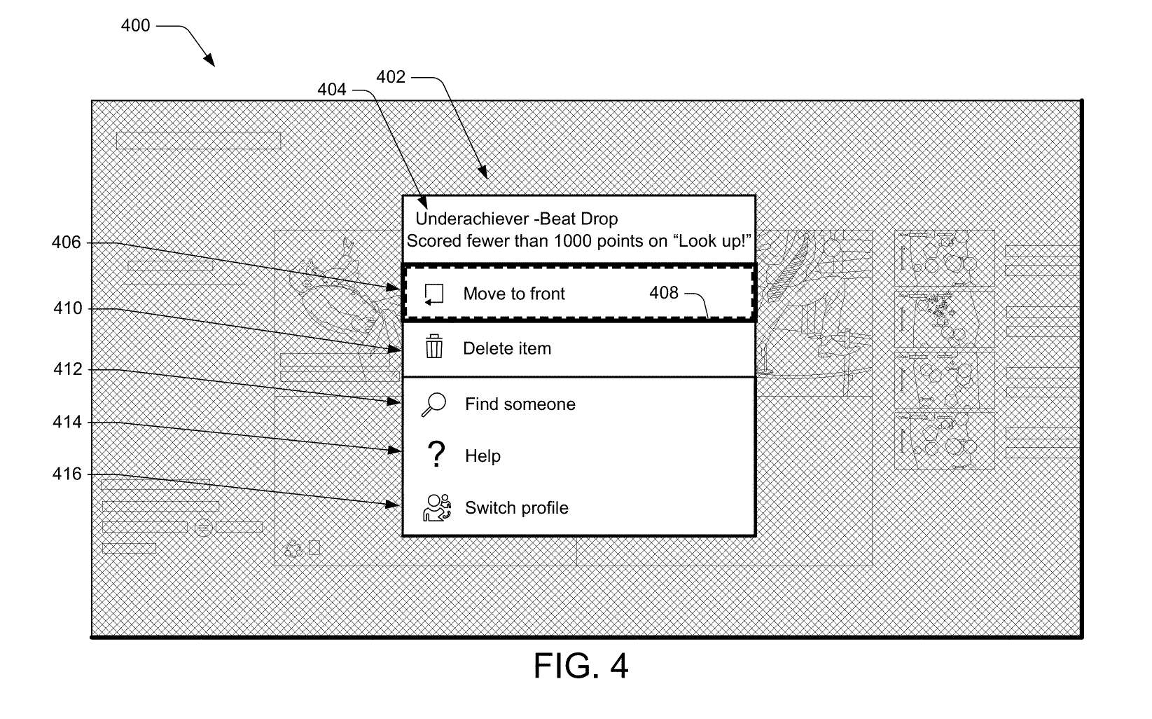

FIG. 4 shows a graphical representation of an example showcase display 400 for a user of a multi-user system. In the illustrated example, showcase display 400 includes menu 402 displayed in a pop-up arrangement over the contents of showcase display 300. Menu 402 can be displayed in various arrangements, e.g., drop-down or adjacent to content and accessible by swiping. The example menu 402 can include description 404, which can be a system-generated or system-stored description of the relevant user-linked content item. In the illustrated example, the user-linked content item is “Underachiever,” represented in content slot 302, FIG. 3. Menu 402 can include move-to-front control 406. In the illustrated example, highlight frame 408 shows that move-to-front control 406 is selected and can be activated upon an appropriate user input (e.g., a press of an A button, an X button, a MENU button on a gamepad, etc.). Menu 402 can also include delete-item control 410. Upon actuation of delete-item control 410, the selected user-linked content item can be removed from the corresponding content slot 302, 304. In an example, the selected user-linked content item can be removed entirely, e.g., removed from computer-readable media 112, upon actuation of delete-item control 410. In an example, the selected user-linked content item can be retained on, e.g., computer-readable media 112 upon actuation of delete-item control 410. This can permit the selected user-linked content item to be added back into the user's showcase at a future time. In the illustrated example, menu 402 includes three general (non-item-specific) menu items: find-someone control 412, help control 414, and switch-profile control 416. General and item-specific menu items listed above are examples and more, fewer, or different menu items may be used in any combination.

Still referring to FIG. 4 and also referring back to FIG. 3, in an example, menu 402 can include a “rearrange” control (not shown) that places showcase display 300 in a “rearrange” mode. In this mode, user input on, e.g., a gamepad or other directional-input device can cause the selected showcase item (e.g., “Underachiever-Beat Drop” in FIG. 3) to move per the user input. Pressing a directional pad to the right, e.g., would move “Underachiever-Beat Drop” (the selected item, as indicated by selection frame 322) to the right into content slot 304 and thus cause “Gated Community-Beat Drop” to move left from content slot 304 into content slot 302. User input, e.g., a press on a menu button or action button such as A B, etc., can cause rearrange mode to be terminated, after which menu 402 or showcase display 300 (with updated positions) can be displayed. In an example, a press of an A button causes the new arrangement of user-linked content items to be saved and rearrange mode to be terminated. In an example, a press of a B or MENU button causes the new arrangement of user-linked content items to be discarded and rearrange mode to be terminated.

Still referring to FIGS. 3 and 4, in various examples, simultaneous multi-button presses on a gamepad or other input device can be used to rearrange items. For example, from showcase display 300, a computing device 104 displaying showcase display 300 can respond to input that a joystick or directional pad is moved while a predetermined button, e.g., an X button, is held by moving the user-linked content item with selection frame 322 to an adjacent content slot 302, 304 in the direction indicated in the input, exchanging places with other user-linked content items when moving into an occupied content slot 302, 304.

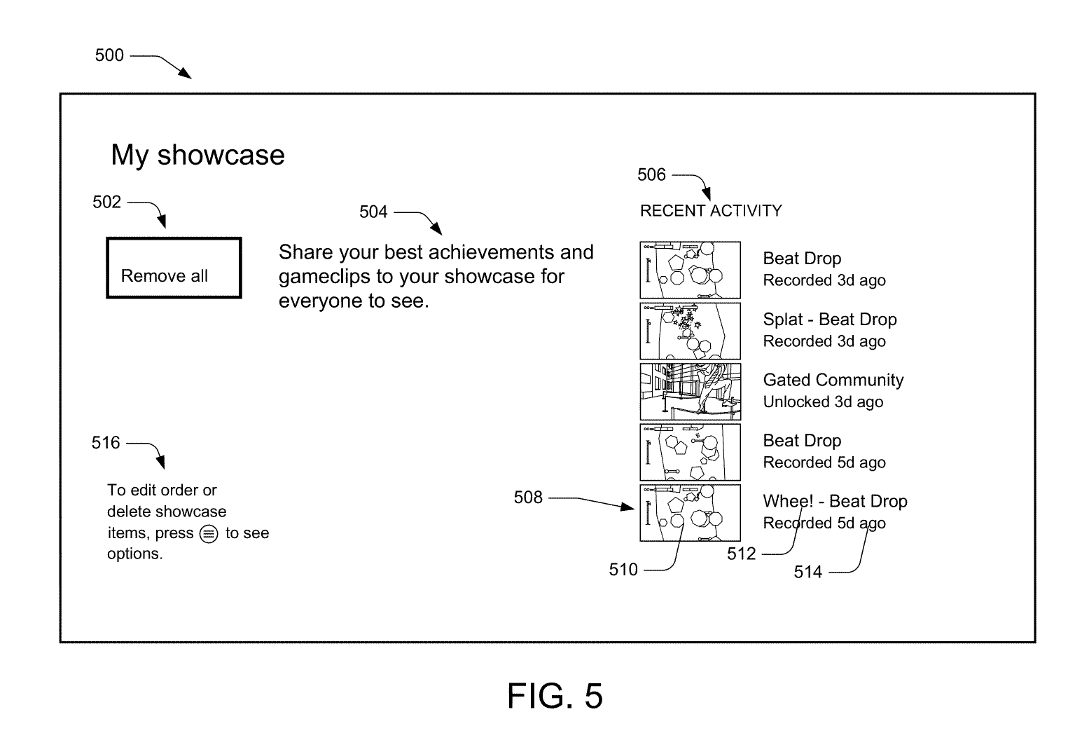

FIG. 5 shows a graphical representation of an example showcase display 500 for a user of a multi-user system. The example showcase display 500 is for a user who has not yet recorded any items in that user's showcase. Accordingly, clearing control 502 is inactive (not responsive to selections; shown grayed out). Welcome message 504 prompts a user to add items to the user's showcase. User-activity feed 506 shows recent user-linked content items that can be added to the showcase. In various examples, for one or more of the user-linked content item(s) in user-activity feed 506, e.g., user-linked content item 508, user-activity feed 506 can include one or more of a respective visual representation, e.g., visual representation 510, a respective description 512, e.g., a system-generated description or name of the user-linked content item, and a respective recency message 514, e.g., an indication of when or how recently the user-linked content item was created or earned. Instructional message 516 can be displayed to indicate further choices of action to the user. In the example shown, no content slots are displayed. In various examples, visual placeholders (not shown) of one or more content slots can be presented as part of showcase display 500 to visually afford placing user-linked content items into the showcase. In an example using a two-slot showcase, two dotted rectangles can be presented below welcome message 504 to suggest to the user selecting, dragging-and-dropping, or otherwise indicating two items be moved into the showcase. An example of such an affordance is a downward-pointing arrow in dashed-outline rounded rectangle to afford adding media items to an empty playlist.

FIG. 6 is a graphical representation of an example profile display 600. Profile display 600 includes a visual representation 602 of an item of user-linked content. Identification information 604 can include avatar 606, handle 608 (also referred to as a “gamertag” or “screen name”), location information 610, e.g., provided by the user, and/or biographical information 612, e.g., provided by the user. In various examples, viewing control 614 is responsive to selection to preview the user's showcase. In various examples, editing control 616 is responsive to selection to permit the user to edit the user's showcase, e.g., as described above with reference to FIGS. 2-5.

Controls 614 or 616 can be displayed at all times, or only displayed when a cursor or other focus indicator highlights visual representation 602. In an example, when an indicator such as a cursor, a mouse pointer, a selection box, etc. is positioned over visual representation 602, the indicator can be displayed, a color haze can be overlaid on visual representation 602, visual representation 602 showing video can be paused, controls 614 and/or 616 can be transitioned from a hidden state to a visible state, or any combination thereof. These effects can be undone when the cursor is moved out of the area of visual representation 602.

In the illustrated example, menu 618 is displayed in profile display 600. Menu 618 can include options to change a characteristic color used to represent the user, to change user-provided location information 610 or user-provided biographical information 612, to configure the user's avatar 606, or to change handle 608.

In the illustrated example, activity feed 620 is displayed in profile display 600 spaced apart from visual representation 602 of showcase items. In this example, the showcase is a separate section visually distinguished from activity feed 620. In an example, activity feed 620 on profile display 600 includes message control 622. Upon activating message control 622, a user can add a message to activity feed 620 for access by users of the multi-user system. Activity feed 620 shows user-linked content, e.g., user-linked content items 624, 626. In at least one example, activity feed 620 also shows content linked with other users (in the illustrated example, users other than “BloomquistHarpr”). In some of these examples, user-linked content items 624, 626 can be added to BloomquistHarpr's showcase using a sharing control (not shown) in activity feed 620, but user-linked content of other users cannot be added to BloomquistHarpr's showcase in these examples.

In at least one example, profile display 600 or a user's “home screen” (not shown) can include controls for adding displayed items, e.g., items in activity feed 620, to a showcase or other user-information data store. In at least one example, if no user-linked content items are associated with content slots, a placeholder can be displayed in place of visual representation 602. Examples of placeholders can include color bars, fields of a user-selected or default color, clipart, or screenshots from games the user has recently been playing.

In an example, profile display 600 is responsive to command inputs to scroll to reveal additional information. In the example shown, the profile display 600 can be scrolled to the right (contents shifted left), e.g., by a swiping motion on a touchscreen, to reveal portions of activity feed 620 clipped by the right edge of profile display 600. Additional information can be included in the profile display 600, e.g., in portions not shown in FIG. 6 but available by scrolling. Examples can include software currently running, e.g., games currently being played by other users, games or other items on a “follow” list, or “friend” designations of other users of the multi-user system.

In an example, when Bob visits BloomquistHarpr's profile page, Bob sees a similar page to profile display 600, but without editing control 616.

In various examples, when Bob visits Alice's profile display 600, editing control 616 is not displayed. In an example, a montage or video loop is displayed as visual representation 602.

FIG. 7 shows a graphical representation of an example showcase display 700 for a user of a multi-user system, which can be accessed and/or displayed responsive to selection of viewing control 614. The illustrated showcase shows user-linked content items for user “xblsocial034,” as indicated by identification information 702. Content slots 704, 706, 708 are shown, each including a respective summary visual representation 710, 712, 714 representing a respective item of user-linked content. Summary visual representations 710, 712, 714 can have any aspect ratio, e.g., 16×9, 4×3, etc.

Each content slot 704, 706, or 708 can include a type indicator. In the illustrated example, content slot 704 includes type indicator 716. Type indicator 716 includes a graphical icon of a film and a gamepad, indicating that the user-linked content item in content slot 704 is a gameplay video. Other visual representations of the type of the user-content item can also be shown. By contrast, type indicator 718 in content slot 706 includes a graphical icon of a trophy, indicating that the user-linked content item in content slot 706 is an achievement or in-game award. In this example, content slot 708 includes type indicator 720 showing a film strip, indicating that the corresponding user-linked content item is a gameplay video. Other icons or representations can also be used. For aggregate items of user-linked content, as discussed above with reference to FIG. 2, multiple type indicators such as type indicators 716, 718 can be displayed in a single content slot 704, 706, or 708. Alternatively or additionally, a single combined-type indicator (e.g., a filmstrip icon with a trophy icon superimposed thereupon) can be displayed in the content slot 704, 706, or 708 showing the aggregate item. Type indicators 716, 718, and 720 can represent type indicators 310 or 312, FIG. 3.

Content slots 704, 706, or 708 can also include descriptions or other supplemental information, e.g., superimposed over or proximal to summary visual representations 710, 712, or 714, or proximal to type indicators 716, 718, or 720, as illustrated. This is similar to the annotations shown in FIGS. 2 and 3. Each content slot 704, 706, or 708 can include status information. In the illustrated example, the description text “Beat Drop” is superimposed over summary visual representations 710 and 714 and indicates the game from which the gameplay videos were captured. In the illustrated example, the description text lines “Top it Off-Beat Drop” and “Used a bass boost refill” are superimposed over summary visual representation 712. The “Top it Off” line is the system-provided name of the achievement associated with content slot 706. The “Used a” line is a system-provided description of the “Top it Off” achievement in the “Beat Drop” game.

In the illustrated example, content slot 704 includes status information 722. In the illustrated example, status information 722 indicates that the user-linked content item in content slot 704 has been “favorited” twice (labeled 724, “♡ 2”), commented on twice (labeled 726, the speech balloon with number 2 to its right) and shared twice (labeled 728, the icon similar to the recycling icon with number 2 to its right). In the illustrated example, content slot 708 includes caption 730 (“Where is Indiana Jones when you need him?”), which can represent caption 320, FIG. 3, and can be, e.g., provided by a user. In the illustrated example, content slot 704 is highlighted, as indicated by highlight frame 732.

When a user actuates content slot 704, 708, or another content slot associated with a game video, the game video can be played, e.g., with accompanying audio, e.g., in place of respective summary visual representation 710, 714, in a popup window over showcase display 700, or in a separate user-interface screen or display (e.g., full screen). When a user actuates content slot 706 or another content slot associated with non-video content (e.g., screenshots or achievements), the content, supplemental information about the content, or a combination thereof can be displayed in place of summary visual representation 712, in a popup, or in a separate screen.

Showcase display 700 or a similar “showcase” or other user-data display can be shown or otherwise presented in a variety of contexts. Showcase display 700 can be a Web page or can be included or framed in a Web page, e.g., as a dedicated section of a user profile on a social network or of a persona on a gaming network. Showcase display 700 can be presented to a user via a gaming system, software running on a personal computer, a smartphone app, or any system capable of retrieving profile information from the multi-user system and displaying the profile information. Showcase or other profile information can be shown in various forms, e.g., a three-column, two-row display such as those shown in FIG. 2, or a mobile-optimized view on a smartphone (e.g., one column, six rows). In various examples, showcase displays such as showcase displays 200, 300, 500, or 700 can be displayed in any layout, e.g., grid, row, column, or cloud, and can be arranged in scrollable panes or fixed in position on screen.

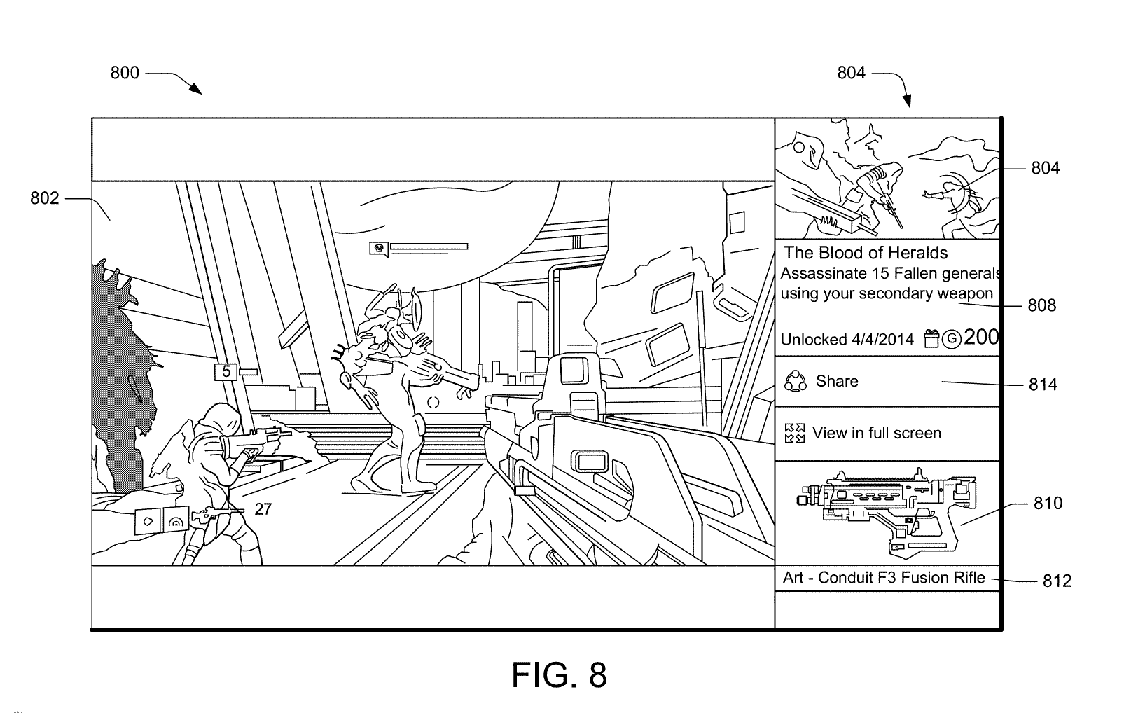

FIG. 8 shows a graphical representation of an example gaming-system display 800 in a multi-user gaming system. The example gaming-system display 800 can be presented by a computing device 104. The example gaming-system display 800 can include gameplay window 802 showing action happening in the game. That is, the contents of gameplay window 802 are substantially determined via execution of the computer program instructions of a game module of the game. The illustrated gaming-system display 800 includes sidebar 804 including visual representation 806 and supplemental information 808 of a first item of user-linked content (achievement “The Blood of Heralds”). The illustrated sidebar 804 includes visual representation 810 and supplemental information 812 of a second item of user-linked content (collateral “Conduit F3 Fusion Rifle”). In the illustrated example, visual representation 806 corresponds to an in-game achievement, and visual representation 810 corresponds to an in-game collateral item accompanying the in-game achievement. In various examples, for any given item of user-linked content, gaming-system display 800 can show a visual representation, supplemental information, or both. Any or all of visual representations 806, 810 and supplemental information 808, 812 can be presented on gaming-system display 800, e.g., when the in-game achievement is earned.

Visual representations 806 and 810, and supplemental information 808 and 812, can be substantially determined via execution of computer program instructions of an achievements module. The achievements module can exchange data with the game module, e.g., of which game is being played and which achievements the user has won. The achievements module can display information on a portion of the gaming-system display 800, e.g., in sidebar 804, as shown. Sidebar 804 can be presented as a popup or full-screen interface, or as a sidebar snapped to any edge of gaming-system display 800 or snapped or docked to another sidebar (not shown). The achievements module can be part of the game or can be separate from the game, e.g., as a shell or operating-system module.

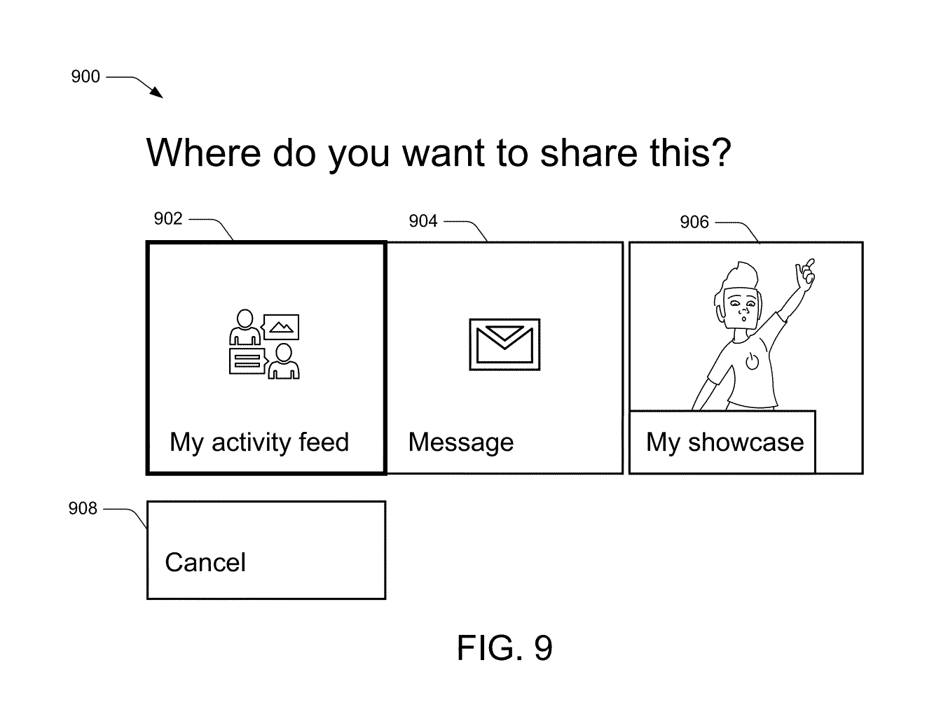

A share control 814 can be presented on gaming-system display 800 in association with visual representations 806, 810. Actuation of share control 814 permits sharing the in-game achievement or collateral via a showcase, as discussed below with reference to FIGS. 9 and 10.

FIG. 8 shows an example of a context in which user-linked content can be associated with a user profile. Similar displays or techniques can be used to establish such associations from an operating-system shell, a productivity application, or anywhere user-linked content can be posted to a multi-user system. In an example, when a video is being played on a computing device 104, and a Pause or Menu command is received, a menu including a share control 814 can be displayed. In this way, part of the video, e.g., the current frame or current screen, can be shared or added to a showcase. Referring back to FIG. 6, in an example, activity feed 620 can include a share control 814 for any items in activity feed 620 that are user-linked content (as opposed to, e.g., content linked to other users). Activating that share control 814 permits users to readily share user-linked content, e.g., via a showcase.

FIG. 9 shows a graphical representation of an example destination-selection user interface 900. Destination-selection user interface 900 can be presented, e.g. upon actuation of share control 814, FIG. 8, or in response to a selection of a user-linked content item in user-activity feed 232, FIG. 2, user-activity feed 326, FIG. 3, or user-activity feed 506, FIG. 5. In at least one example, destination-selection user interface 900 can be displayed as a popup over various screens, e.g., an gaming-system display such as gaming-system display 800, a video playback display, a profile view (e.g., profile display 600, FIG. 6), a home screen, or a showcase display such as showcase displays 200, 300, 500, and 700. In at least one example, destination-selection user interface 900 can be displayed as a full-screen dialog. Destination-selection user interface 900 can be displayed in a modal configuration or a non-modal configuration.

Destination-selection user interface 900 can include one or more destination selector(s) 902, 904, 906. Destination-selection user interface 900 can include a cancel control 908. Destination-selection user interface 900 is responsive to actuation of cancel control 908 to dismiss destination-selection user interface 900 without taking action. Destination-selection user interface 900 is responsive to one or more destination selectors 902, 904, 906 to select a respective data area or slot with which to associate an item of user-linked content. In an example in which Alice actuates share control 814, the item of user-linked content can be the achievement represented by visual representation 806 (“The Blood of Heralds”) or the collateral represented by visual representation 810 (“Conduit F3 Fusion Rifle”). In response to the actuation of destination selector 902, Alice's activity feed can be selected to receive an indication or representation of the user-linked content item. In response to the actuation of destination selector 904, an indication or representation of the user-linked content item can be provided to a messaging program. The messaging program can permit Alice to inform another user about the user-linked content via a messaging protocol or network, e.g., electronic mail or multimedia message service (MMS). For example, the messaging program can attach a reference to the user-linked content item to an electronic-mail message, providing the recipient of the message read access to the user-linked content item without requiring the item be copied. In response to the actuation of destination selector 906, Alice's showcase (specifically, a content slot therein) is selected to be associated with the user-linked content item. Upon actuation of any of destination selector(s) 902, 904, 906, a confirmation view can be displayed.

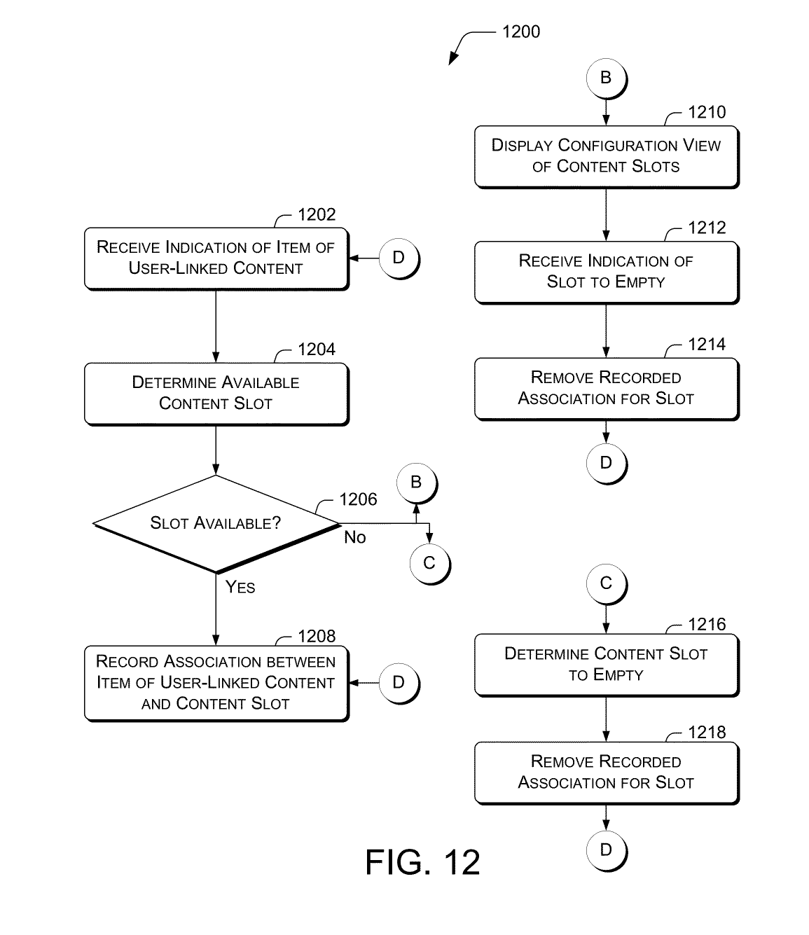

FIG. 10 shows a graphical representation of an example confirmation view 1000. Confirmation view 1000 can show information 1002 about the user-linked content item, e.g., a title or description of the item. Confirmation view 1000 can show a representation of the user-linked content item, in an example visual representation 1004. Confirmation view 1000 can include editing control 1006, in this example a textbox, permitting the user to enter a caption or other information to accompany the user-linked content item when the item is added to the user's showcase. An example caption is caption 246, “A New Start.” Editing control 1006 can permit adding annotations of various types, e.g., text, images, or smileys. Confirmation view 1000 can include confirmation control 1008. In response to actuation of confirmation control 1008, an association is recorded between the item of user-linked content and the selected destination (FIG. 9), e.g., a content slot in the user's showcase. This can be as described below with reference to block 1206, FIG. 12. In various examples, confirmation view 1000 can include a sharing control (“Share this”), a captioning control (“Add a caption”), and a cancel control. Upon actuation of the captioning control, the user can be prompted to enter a caption.

In the example shown, the achievement identified by information 1002 (“The Blood of Heralds”) and the in-game collateral item represented by visual representation 1004 (“Conduit F3 Fusion Rifle”) are an aggregate item of user-linked content. Accordingly, visual representation 1004 represents the achievement and the collateral item even though only the collateral item is visually depicted in the example of FIG. 10. In various examples not shown, an achievement or an in-game collateral item can be the item of user-linked content and not be part of an aggregate item. In an example, the Conduit F3 can be the item of user-linked content and information 1002 can read “Destiny Weapons” (in place of the illustrated “Destiny Achievements”) and “Conduit F3 Fusion Rifle” (in place of the illustrated “The Blood of Heralds”).

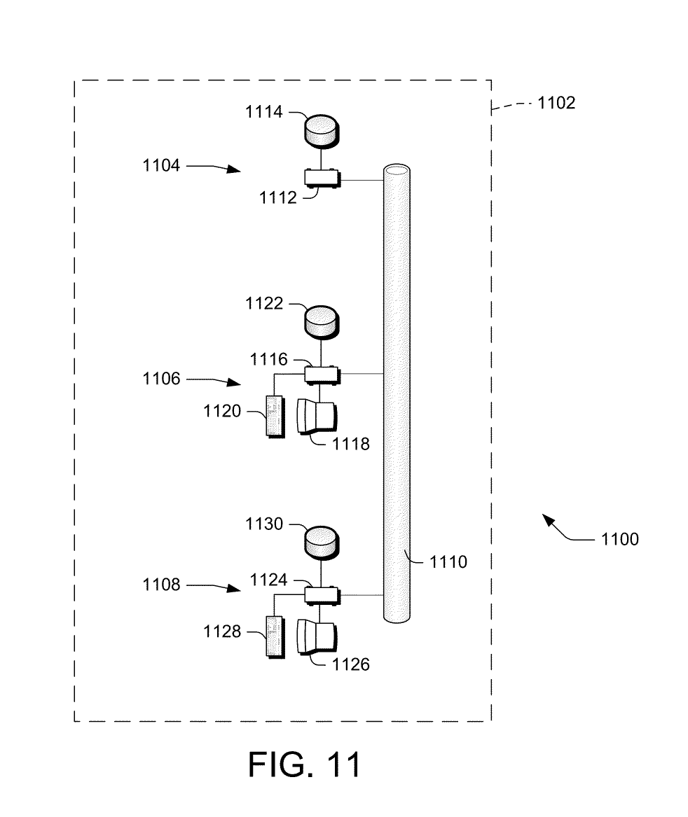

Various user-interface screens and elements have been described above with reference to, for example, showcases of user-linked content items. Various examples provide Alice or other users of multi-user systems the ability to share targeted information that is relevant to the users providing the information. This can permit Bob or other users to more quickly determine relevant information about Alice in a way that has reduced bandwidth and storage requirements compared to prior schemes. Some prior customization schemes included, e.g., custom text color selection or custom background images. Unlike such schemes, showcase items (user-linked content items associated with content slots) can be displayed in a manner visually distinct from other elements of a user interface of the multi-user system. This can reduce the burden on system users of locating information about each other, and can increase user freedom in the selection of showcase items. Technical effects of various aspects include reducing the amount of bandwidth required to transfer user information, adapting the display of user information to the characteristics of a particular client device such as a terminal 1108, FIG. 11, and improving user efficiency by reducing the amount of time and effort required for, e.g., Alice to locate and retrieve pertinent information about Bob.

### Illustrative System

FIG. 11 is a block diagram that illustrates an example system 1100 for communicating information between users of a multi-user system 1102, which can represent environment 100. The communicated information can include user-linked content. System 1100 permits users to, e.g., promote their accomplishments or achievements to each other with reduced bandwidth requirements compared to prior schemes. The illustrated multi-user system 1102 includes a server 1104 and two terminals 1106, 1108. The server 1104 and the terminals 1106, 1108 can represent computing devices such as computing devices 102 and/or 104. The server 1104 and the terminals 1106, 1108 can intercommunicate via network 1110, which can represent network 106, FIG. 1. Network 1110 is represented as a bus, but can have any topology, including bus, star, or ring. Network 1210 can be, e.g., the Internet, a private network, or a virtual private network (VPN). Terminals 1106, 1108 can selectively connect to, and disconnect from, network 1110 or server 1104.

Server 1104 can include a processing unit 1112, which can represent processing unit 110, and one or more computer-readable media 1114, which can represent computer-readable media 112. Computer-readable media 1114 can include data storage, structured or unstructured, such as a database or data warehouse. In some examples, computer-readable media 1114 include a corpus or a relational database with one or more tables, arrays, indices, stored procedures, and so forth to enable data access including one or more of hypertext markup language (HTML) tables, resource description framework (RDF) tables, web ontology language (OWL) tables, or extensible markup language (XML) tables, for example. Computer-readable media 1114 can store data for the operations of processes, applications, components, or modules stored in computer-readable media 1114 or executed by processing unit 1112. In at least one example, the computer-readable media 1114 may store user information such as that shown in FIGS. 2, 3, 6, and/or 7. For example, the computer-readable media 1114 may store user-linked content items or associations between content slots and user-linked content items as discussed herein, e.g., with reference to FIGS. 2 and/or 11.

Terminal 1106 can include a processing unit 1116, which can represent processing unit 110, a display 1118, and a user-operable input device 1120 (represented graphically as a keyboard). Terminal 1106 can also include computer-readable media 1122, which can represent computer-readable media 112. Terminal 1108 can include a processing unit 1124, which can represent processing unit 110, a display 1126, and a user-operable input device 1128 (represented graphically as a keyboard). Terminal 1108 can also include computer-readable media 1130, e.g., a computer storage medium, which can represent computer-readable media 112.

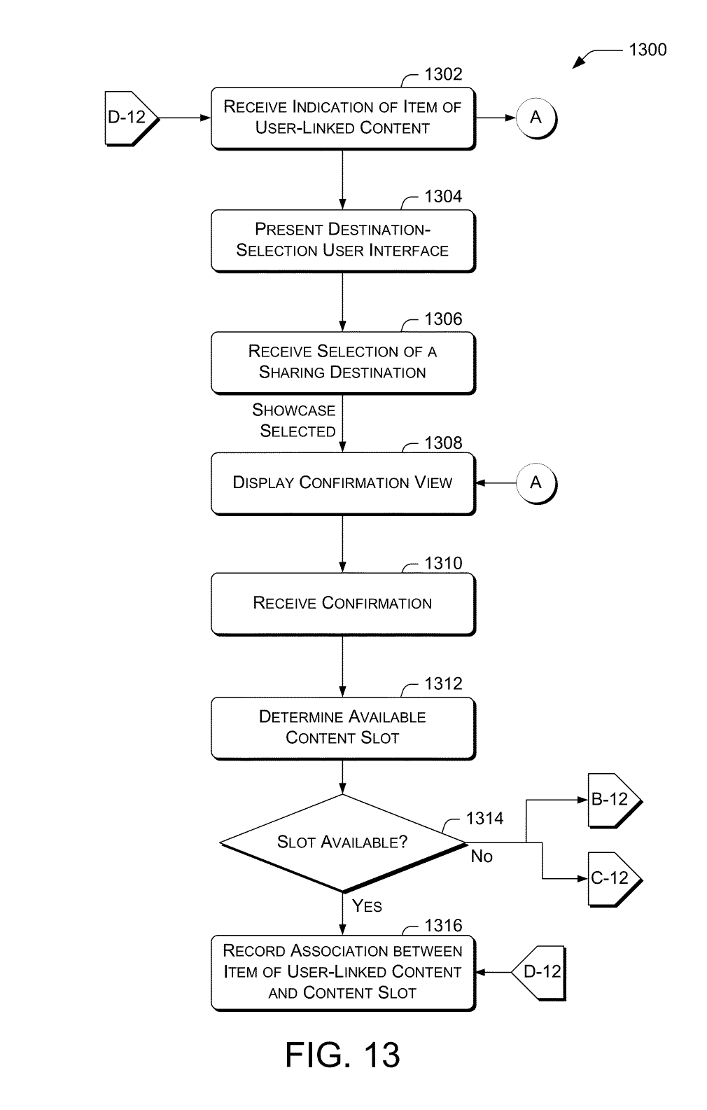

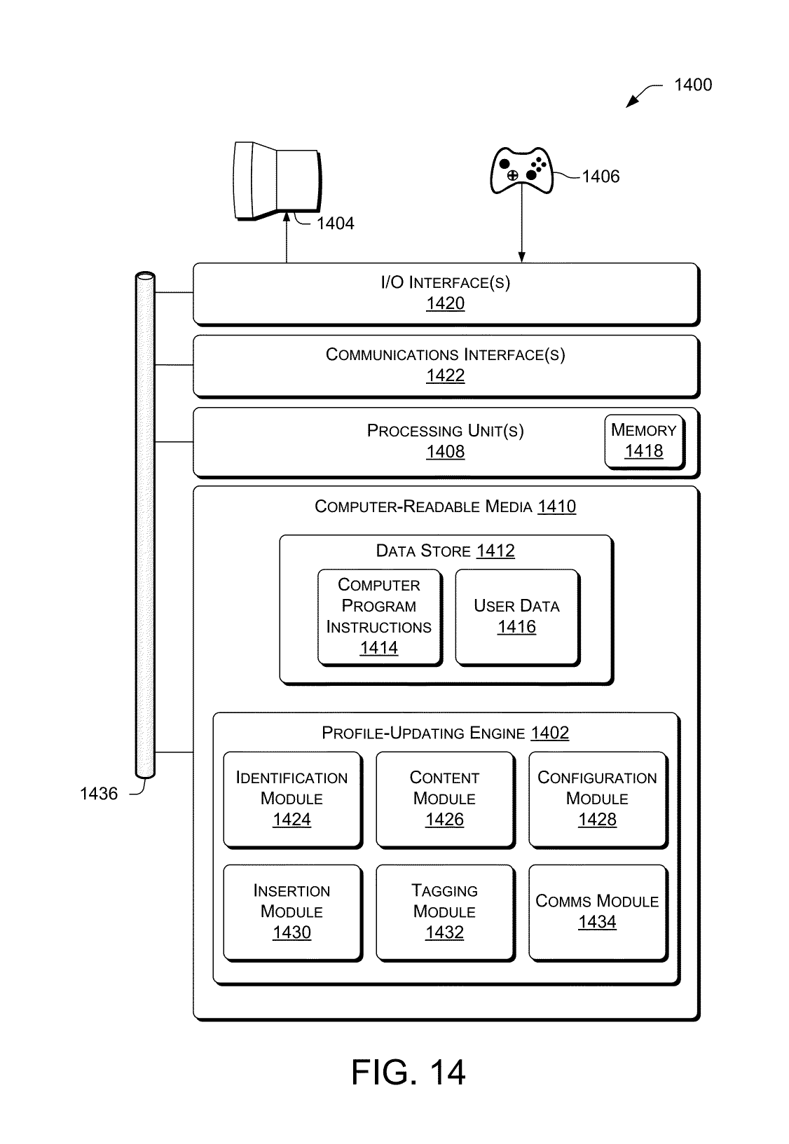

A user can use terminal 1106 to provide information, e.g., showcase information. Showcase information can be provided, e.g., using user interface elements described above with reference to any of FIGS. 2-5 and 8-10. Showcase information can be provided, e.g., using methods described below with reference to FIG. 13. Terminal 1106 can transmit at least part of the user-provided information, which can include user-linked content items or references thereto, via network 1110 to server 1104. This can be done as described below with reference to FIG. 14. In at least one example, the user-provided information transmitted by terminal 1106 can include privacy or access-control information indicating which user(s), program(s), device(s), or group(s) or type(s) of any of those, will have access to one or more items of content, e.g., showcase display 700, FIG. 7. Server 1104 can store at least part of the transmitted user-provided information, and can enforce the transmitted privacy or access-control restrictions. User(s) can be identified, e.g., specifically by name, or by group. Device(s) can be identified, e.g., by their 48-bit Ethernet MAC (Media Access Control) addresses. Privacy or access-control information can include information about the level of access to user information permitted to anonymous users. In at least one example, user information can be designated as being accessible only to the user that created the user information, or to specific users, e.g., specific named users or users in a “friends” group or other user group, or to any user. In an example, Alice has two smartphones: one for personal use and one for work use. Alice can specify in the access-control information that user information shall not be provided to the work smartphone. This permits Alice to share user-linked content while being confident that bandwidth and storage on the work smartphone will not be consumed by the user-linked content.

Server 1104 can transmit at least part of the stored user-provided information to terminal 1108, e.g., on request from terminal 1108 (“pull”) or according to computer program instructions in server 1104 (“push”). Terminal 1108 can display or otherwise present at least part of the user-provided information received from server 1104, e.g., using user interface elements describe above with reference to FIGS. 6-7. This can be done as described below with reference to FIG. 15.

In various examples, user information such as associations between users and user-linked content items is stored entirely on server 1104, or is shared between two or more of server 1104 and terminals 1106, 1108. In an example, user information is stored on server 1104 and cached on terminals 1106, 1108. A user can use any computing device 102 and/or 104 capable of accessing the multi-user system 1102 to send information, e.g., to server 1104 for inclusion in that user's profile, or to retrieve information about another user from, e.g., server 1104. Terminals 1106, 1108 or software running thereon can display profile information to be uploaded or that has been retrieved in a way depending on the available display and processing capacity of the terminals 1106, 1108. In an example, as discussed above with reference to FIG. 2, Alice's showcase includes six game clips ranging between about five seconds and about 30 seconds. An example terminal including a multi-core CPU can display all six game clips as a montage, either sequentially or simultaneously. An example terminal including a lower-power CPU can display six thumbnails rather than the video, and can display one video at a time in response to selection of one of the thumbnails at a time. In at least one example, server 1104 is configured to selectively transcode or otherwise process user-linked content or other user information upon request from terminal 1108 or another requester of user information. For example, terminal 1108 can request a specific bit rate of video from server 1104, and server 1104 can transcode game clips such as those referenced in FIG. 2 into video of at most the specific bit rate, then send the transcoded game clips to terminal 1108 in place of original, higher-bandwidth game clips.

### Illustrative Processes

FIG. 12 is a flow diagram that illustrates an example process 1232 for updating user information, e.g., by adding items to a showcase display such as that shown in any of FIGS. 2-5 and 7. Example functions shown in FIG. 12 can be implemented on or otherwise embodied in one or more computing device(s) 102 and/or 104. In various examples, example functions can be implemented using Web pages served by a computing device 102 and accessed by a computing device 104, or as software running on a computing device 104. For the sake of illustration, the example process 1232 is described below with reference to processing unit 1116 in terminal 1106. However, other processing unit(s) such as processing unit 110 and/or other components of computing device(s) 102 and/or 104 can carry out step(s) of described example processes such as process 1232.

At block 1200, processing unit 1116 receives an indication of an item of user-linked content. In various examples, the indication can be or include, e.g., data of an actuation of a selection from a user-activity feed 232, 326, 506, or data of an actuation of share control 814 with respect to a particular user-linked content item, e.g., as discussed above with reference to FIG. 2 or 8.

At block 1202, an available content slot of a predetermined number of content slots, e.g., in a showcase, is determined. This can be done by querying a database for content-slot records not associated with user-linked content items (e.g., records having a NULL foreign key for a user-linked content item). In an example, the available content slot is determined by transmitting a request for an available slot via a communications channel, e.g., from terminal 1106, and receiving a response via the communications channel indicating the available slot.

At decision block 1204, which can be part of block 1202, it is determined whether or not a slot of the predetermined number of content slots is available. Continuing the examples of block 1202, if no record was found for an available content slot, or if no response was received or a no-slot-available response was received via the communications channel, it can be determined that no slot is available. If no slot is available, block 1200 or 1202, or decision block 1204, can provide an error message or status indicator, e.g., via a user interface. The method can terminate after decision block 1204 if no slot is available. In an example, if no slot is available, decision block 1202 can be followed by block 1208 or block 1214. The choice between block 1208 and block 1214 can be made, e.g., according to a user preference stored in a computer-readable medium such as computer-readable media 1114 or 1122, FIG. 11. In an example, the user preference is stored as part of a user profile maintained by the multi-user system 1102.

At block 1206, an association is recorded between the item of user-linked content and the available content slot. The association can be recorded in a computer-readable medium, e.g., computer-readable media 1114 or other media, e.g., on a network server or computing device 102 and/or 104. The network server can then provide information about the association or the user-linked content upon request to computing devices, e.g., computing devices 104 and/or 102. The method can terminate after block 1206.

In at least one example, at block 1208, in response to said determining that no slot is available (block 1202 or decision block 1204), a configuration view of the content slots is displayed. An example of a configuration view can be showcase display 300, FIG. 3.

At block 1210, an indication of one of the content slots to empty is received. The indication can include, e.g., a selection of a clearing control 344, FIG. 3, to empty all of the content slots. In an example, the configuration view is configured to provide a menu such as menu 402 shown in FIG. 4 upon selection of one of the content slots 302, 304 of the showcase display 300. The indication in this example can be the selection of a delete-item control 410 in menu 402, FIG. 4, for a particular content slot 302, 304. The indication can be received via a selection control (not shown) on a confirmation view 1000. In various examples, a configuration view similar to showcase display 300 but without user-activity feed 326 can be displayed (block 1208) and one of the displayed content slots can be selected to be emptied (block 1210).

At block 1212, a recorded association between the indicated one of the content slots and a corresponding item of user-linked content is removed. The indicated one of the content slots is thus the available content slot. In an example, the recorded association can be removed by editing a corresponding database record (e.g., using an SQL UPDATE or DELETE statement) or otherwise altering data on a computer-readable medium, e.g., computer-readable media 1114 to remove the association from the data accessible to processing unit 110. In an example, the recorded association can be removed by transmitting via a communications link, e.g., from terminal 1106, a command to remove the association. Various examples of such commands can include Hypertext Transfer Protocol (HTTP) POST or DELETE requests. Block 1212 can be followed by block 1206 or by block 1200. The choice of block 1206 or block 1200 can be made, e.g., based on a user preference or a system policy setting stored, e.g., in computer-readable media 112. Removing an association based on a received indication, e.g., received from a user, can permit a user to retain in that user's showcase achievements or other user-linked content regardless of the age of that user-linked content.

In at least one example, at block 1214, in response to said determining that no slot is available (block 1108), one of the content slots to empty is automatically determined, e.g., by a processing unit 110. The determining can be, e.g., based at least on a respective recency or a respective rating of items of user-linked content corresponding to the content slots. For example, the content slot holding the least-recently earned user-linked content item can be determined. In an example, the least-recently-updated content slot, i.e., the content slot that was least recently associated with a user-linked content item, is determined to be the content slot to empty. In an example, a randomly- or pseudorandomly-selected content slot, or a predetermined content slot (e.g., the leftmost in FIG. 2) is determined to be emptied.

At block 1216, a recorded association between the determined one of the content slots and a corresponding item of user-linked content is removed. The determined one of the content slots thus becomes the available content slot, in this example. Removing the association can be performed by, e.g., removing a database record storing the association, by transmitting a command to remove the association, or otherwise as discussed above with reference to block 1212. Block 1216 can be followed by block 1206 or by block 1200, e.g., according to a system or user preference setting as discussed above with reference to block 1212. Removing an association based on an automatic determination can permit a user to readily maintain up-to-date information with fewer interaction steps and reduced bandwidth and display requirements.

FIG. 13 is a flow diagram that illustrates an example process 1300 for updating user information, e.g., by adding items to a showcase display such as that shown in any of FIGS. 2-5 and 7. Example functions shown in FIG. 13 can be implemented on or otherwise embodied in one or more computing device(s) 102 and/or 104. In various examples, example functions can be implemented using Web pages served by a computing device 102 and accessed by a computing device 104, or as software running on a computing device 104. For the sake of illustration, the example process 1300 is described below with reference to processing unit 1116 in terminal 1106. However, other processing unit(s) such as processing unit 110 and/or other components of computing device(s) 102 and/or 104 can carry out step(s) of described example processes such as process 1300.

At block 1302, processing unit 1116 receives an indication of an item of user-linked content. This can be done, e.g., as described above with reference to block 1200, FIG. 12. In various examples, the indication can be or include, e.g., data of an actuation of a selection from a user-activity feed 232, 326, 506, or data of an actuation of share control 814 with respect to a particular user-linked content item, e.g., as discussed above with reference to FIG. 2 or 8. In the illustrated example, block 1302 is followed by block 1304 to permit sharing the user-linked content item to a user-selected destination (e.g., to a showcase, to an activity feed, or via a message), e.g., as described above with reference to FIG. 9. In various examples, block 1302 is followed by block 1308 to permit sharing the user-linked content item directly to a showcase. In various examples, block 1302 is performed after block 1212 or block 1216, as graphically indicated by the “D-12” off-sheet connector.

At block 1304, after said receiving the indication (block 1302), a destination-selection user interface is presented, e.g., destination-selection user interface 900 shown in FIG. 9. The destination-selection user interface can include visual representations of a plurality of sharing destinations. At least one of the sharing destinations can be a showcase, as discussed above with reference to FIG. 2.

At block 1306, a selection of one of the sharing destinations is received via the destination-selection user interface. In response to selection of the showcase, block 1306 can be followed by block 1312. In this way, the determining (block 1312, decision block 1314), displaying (block 1308), receiving-confirmation (block 1310), and recording (block 1316) steps can be performed to add the indicated item of user-linked content to the showcase.

At block 1308, a confirmation view is displayed. An example is confirmation view 1000, FIG. 10. The confirmation view can include an indication of the available content slot, e.g., a slot number or identifier, or simply an “add to showcase” or similar user control or caption indicating that at least one content slot is available to receive the user-linked content. The confirmation view can include a representation of the item of user-linked content, e.g., visual representation 1004, FIG. 10.

At block 1310, after block 1308, a confirmation is received. The confirmation can include data indicating a user has selected an “add to showcase” or similar control, e.g., confirmation control 1008. In an example, block 1310 includes receiving an input via a user-operable input device such as a mouse, trackball, joystick, game pad, keyboard, touch sensor, light pen, or light gun. In an example, block 1310 further includes receiving a caption, e.g., via a user-operable input device that provides data to editing control 1006, FIG. 10, or another editing control. The received caption can include, e.g., any text string entered by a user.

At block 1312, an available content slot of a predetermined number of content slots is determined. This can be done, e.g., as discussed above with reference to block 1202, FIG. 12. Block 1312 can be performed before or after block 1310.

At decision block 1314, which can be part of block 1312, it is determined whether or not a slot of the predetermined number of content slots is available. This can be done, e.g., as discussed above with reference to decision block 1204, FIG. 12. If no slot is available, block 1302 or 1304, or decision block 1314, can provide an error message or status indicator, e.g., via a user interface. The method can terminate after decision block 1314 if no slot is available.

In various examples, a “showcase full” error message can be displayed if no slot is available. In at least one example, the user can access a showcase display such as showcase display 300, FIG. 3, and manually remove one or more user-linked content item(s). The method can then resume at block 1302, permitting the user to retry the sharing operation.

In various examples, if no slot is available, decision block 1314 can be followed by block 1208 or block 1214, both FIG. 12, as graphically indicated by the “B-12” and “C-12” off-sheet connectors (respectively) in FIG. 13. In this way, blocks 1208, 1210, and 1212 can be performed to determine an available content slot, or blocks 1214 and 1216 can be performed to determine an available content slot. In various examples, either of block 1212 and block 1216 can be followed by block 1302 or block 1316, as graphically indicated by the “D-12” off-sheet connectors in FIG. 13. The choice of block 1302 or block 1316 can be made, e.g., based on a user preference or a system policy setting stored, e.g., in computer-readable media 112.

At block 1316, in response to the received confirmation, an association is recorded between the item of user-linked content and the available content slot. This can be done, e.g., as described above with reference to block 1206, FIG. 12. In an example in which block 1310 includes receiving a caption, block 1316 further includes recording the caption in association with the item of user-linked content in the computer-readable medium. In various examples, block 1316 is performed after block 1212 or block 1216, as graphically indicated by the “D-12” off-sheet connector.

In at least one example, blocks 1302, 1304, and 1306 are performed in that order. Blocks 1308, 1310, and 1312, and decision block 1314 are then performed in any order, except that block 1310 precedes block 1310 and block 1312 precedes or is performed concurrently with decision block 1314.

### Illustrative Components

FIG. 14 is an illustrative diagram that shows example components of a computing device 1400, which can represent computing device(s) 102 and/or 104 (e.g., 104(1)), 1106. Computing device 1400 can implement the profile-updating engine 1402, which can represent profile-updating module 118, FIG. 1, to permit a user to provide profile information. Computing device 1400 can, e.g., present visual displays such as those shown in any of FIGS. 2-6 and 8-10.

Computing device 1400 can include or be connected to a display 1404, which can be representative of display 1118. Display 1404 can include an organic light-emitting-diode (OLED) display, a liquid-crystal display (LCD), a cathode-ray tube (CRT), or another type of visual display. In an example, display 1404 can have a resolution of 1920×1080 pixels (px). In various examples, display 1304 can have a resolution of 1280×1024 px, 1280×720 px, or 640×480 px.

Computing device 1400 can include or be connected to a user-operable input device 1406 (graphically represented as a gamepad), which can represent user-operable input device 1120. User-operable input device 1406 can include a keyboard, a keypad, or another input device such as those discussed above with reference to block 1310.

The computing device 1400 may include one or more processing unit(s) 1408, which can represent processing unit(s) 110, 1116. Processing unit(s) 1408 can include, e.g., processing unit types described above such as CPU- or GPGPU-type processing unit(s). In various examples, the computing device 1400 may be a server, a desktop computer, another type of electronic device, or another device type noted above, or a combination of any of those, that is capable of hosting one or more processing unit(s) 1408 to process data.

Processing unit(s) 1408 can be configured to execute modules of a plurality of modules in one or more computer-readable media 1410. Computer-readable media 1410 can represent computer-readable media 112, 1122. Examples of modules in computer-readable media 1410 are discussed below. Computer-readable media 1410 can include an operating system, e.g., operating system 116 (omitted for clarity). In the illustrated example, computer-readable media 1410 includes a data store 1412.

In some examples, data store 1412 includes data storage, structured or unstructured, such as a database or data warehouse. In some examples, data store 1412 includes a corpus or a relational database with one or more tables, arrays, indices, stored procedures, and so forth to enable data access including one or more of hypertext markup language (HTML) tables, resource description framework (RDF) tables, web ontology language (OWL) tables, or extensible markup language (XML) tables, for example. Data store 1412 can store data for the operations of processes, applications, components, or modules stored in computer-readable media 1410 or executed by processing unit(s) 1408. In at least one example, the data store may store computer program instructions 1414 (e.g., instructions corresponding to a playable game or other software usable with multi-user system 1102), user data 1416 (e.g., hours played or other data used to compute statistics, save-game states, or profile information), or any combination thereof. Some or all of the above-referenced data can be stored on one or more memories 1418 on board one or more processing unit(s) 1408, such as a memory on board a CPU-type processor or other processor discussed above with reference to processing unit(s) 110. Memories 1418 can include, e.g., a CPU or GPU cache memory, and can be separate from computer-readable media 1410

Computing device 1400 can further include one or more input/output (I/O) interface(s) 1420 to allow computing device 1400 to communicate with input/output devices (not shown) such as user input devices including peripheral input devices (e.g., a keyboard, keypad, a mouse, a pen, a game controller such as user-operable input device 1406, a voice input device such as a microphone, voice-recognition device, or speech-recognition device, a touch input device, a gestural input device such as a touchscreen, and the like) and output devices including peripheral output devices (e.g., a display 1404, a printer, audio speakers, a haptic output, and the like). Computing device 1400 can communicate via I/O interface 1420 with suitable devices or using suitable electronic/software interaction methods. Such communications can be used, e.g., on computing devices 1400 participating in multi-user system 1102. Input data, e.g., of user inputs on a gamepad, can be received via I/O interface(s) 1420, and output data, e.g., of user interface screens, can be provided via I/O interface(s) 1420, e.g., to a user.

The computing device 1400 can also include a communications interface 1422, which can represent communications interface 122. For example, communications interface 1422 can include a transceiver device such as a network interface controller (NIC) to send and receive communications over a network, e.g., as discussed above. As such, the computing device 1400 may have network capabilities. For example, the computing device 1400 may exchange data with computing devices 102 and/or 104 (e.g., laptops, computers, servers, etc.) via one or more networks 106, such as the Internet.

In at least one example, a device 1400 includes the one or more computer-readable media 1410 having thereon a plurality of modules. For example, computer-readable media 1410 of the computing device 1400 may store the modules of the profile-updating engine 1402. The processing unit(s) 1408 can be adapted to intercommunicate and to execute modules of the plurality of modules.

The modules stored on computer-readable media 1410 of the profile-updating engine 1402 can include one or more modules or APIs, which are illustrated as an identification module 1424, a content module 1426, a configuration module 1428, and an insertion module 1430. In at least one example, the profile-updating engine 1402 includes a tagging module 1432. In at least one example, the profile-updating engine 1402 includes a communications module 1434. The number of modules can vary higher or lower, and modules of various types can be used in various combinations. For example, functionality described associated with the illustrated modules can be combined to be performed by a fewer number of modules or APIs or can be split and performed by a larger number of modules or APIs. For example, the identification module 1424, the content module 1426, and the configuration module 1428 can be combined in a single module (e.g., a shell or application programming interface, API, module) that performs at least some of the example functions described below of each of the modules 1424, 1426, 1428. In an example, the configuration module 1428 and the insertion module 1430 can be combined in a single module that performs at least some example functions of the described below of each of the modules 1428, 1430. In various example, the processing unit(s) 1408 can access the module(s) on the computer-readable media 1410 via a bus 1436, which can represent bus 114, FIG. 1. I/O interface 1420 and communications interface 1422 can also communicate with processing unit(s) 1408 via bus 1436.

In various examples, at least some of the modules 1424, 1426, 1428, 1430, 1432, 1434 are configured to present information via display 1404. The at least some of the modules 1424-1434, in these examples, can include logic or computer program instructions to provide pixel values related to the information to be displayed and load those pixel values into a video memory buffer, queue, or other computer-readable medium or other storage device or area from which display 1404 or a controller thereof can retrieve the pixel values for display. The pixel values can be provided or updated at a selected frame rate, e.g., 50 frames per second (fps) or 60 fps. Providing the pixel values can include, for example, rendering text, rendering shapes, scaling or blitting images, resizing content, or cropping content. Providing the pixel values can also include combining pixel values already in the video memory buffer or other storage with newly-determined pixel values, e.g., by exclusive-ORing (XOR) or by alpha blending. Combining pixel values can permit displaying user interface features such as overlays, moving cursors, and item indicators such as highlight frame 408.

In an example, the modules include the identification module 1424 configured to present identification information of a user via the display 1404. For example, identification module 1424 can present identification information 604 including avatar 606 or handle 608, e.g., as shown in FIG. 6.

The content module 1426 can be configured to present, via the display 1404, a content view including a visual representation of an item of user-linked content in association with the identification information. For example, content module 1426 can present the content view including visual representation 602 of the item of user-linked content, and editing control 616, as discussed above with reference to FIG. 6. The visual representation can include, for example, a thumbnail, a motion excerpt from a video such as a game clip, or a graphical representation of a game achievement.

Configuration module 1428 is responsive to selection of the content view via the user-operable input device 1406 to cause to be shown on the display 1404 a configuration user interface. In an example, the user-operable input device 1406 includes a mouse, gamepad, or other device for moving a cursor and selectively providing an action input (e.g., a button click). In various examples, selection of content view can include an action input at editing control 616, or anywhere within a perimeter of visual representation 602. The configuration user interface can include various elements, e.g., discussed above with reference to FIGS. 2 and 3.

Still referring to FIG. 14 and referring also to FIG. 3, the configuration user interface can include showcase display 300 including a predetermined number of content slots, e.g., content slots 302, 304. The predetermined number can be, e.g., any positive integer, between three and ten, between six and eight, between two and 12, six, or nine.

The configuration user interface can include first visual representation(s) of one or more item(s) of user-linked content, e.g., summary visual representations 306, 308, in respective one(s) of the content slots 302, 304. Empty content slots can be presented without visual representations, or with icons or other affordances for associating user-linked content items with content slots, e.g., as discussed above with reference to FIG. 5.

The configuration user interface can include supplemental information, e.g., sharing indicator 318, of at least one of the item(s) of user-linked content in the one(s) of the content slots 302, 304. The supplemental information can indicate, e.g., the type of user-linked content item, activity related to the item in the showcase (e.g., sharing statistics), captions, or descriptions.

The configuration user interface can include second visual representation(s), e.g., visual representation(s) 336, 338, 340, 342, of one or more respective item(s) 328, 330, 332, 334 of user-linked content, the second visual representation(s) (e.g., 336-342) spaced apart from the content slots 302, 304. The second visual representation(s) (e.g., 336-342) can represent items available for insertion into empty one(s) of the content slots 302, 304.

In at least one example, the configuration user interface further includes a sharing control, e.g., sharing control 324, permitting sharing of one or more of the item(s) of user-linked content in the content slots via a communications link.

In at least one example, the configuration user interface includes a rearrangement control such as move-to-front control 406, FIG. 4, permitting rearrangement of item(s) of user-linked content in the content slots. The configuration module 1428 in this example can be responsive to actuation of the rearrangement control via the user-operable input device 1406 to exchange the item(s) in a first one of the content slots and a selected one of the content slots. The configuration user interface can also or alternatively include other rearrangement controls, e.g., controls to rearrange by click and drag, move-to-end, or shuffle. Examples of rearrangement controls are discussed above with reference to FIGS. 2 and 4.

In at least one example, configuration module 1428 is responsive to user-operable input device 1406 during display of the configuration user interface. For example, in the example configuration user interface of FIG. 2, configuration module 1428 can update the displayed highlights or other visual affordances on display 1404 in response to operation of directional controls on the user-operable input device 1406, e.g., the D-pad or analog stick on a controller or the handle of a conventional joystick.

Insertion module 1430 is responsive to the user-operable input device 1406 during display on display 1404 of the configuration user interface. In some examples, insertion module 1430 is responsive to presses of a “select” button (such as an “X” or “A” button, or the menu button 256 noted in instructional message 254, FIG. 2) to take action with respect to a visual representation selected on the configuration user interface (e.g., summary visual representation 214, FIG. 2). In response to a predetermined input from the user-operable input device 1406, e.g., the pressing of a “Select” button, insertion module 1430 inserts one of the item(s) corresponding to one of the second visual representation(s) into one of the content slots. In an example, the inserting includes recording an association between the one of the item(s) and the content slot, e.g., as described above with reference to block 1206, FIG. 12. In at least one example, insertion module 1430 is configured to prohibit insertion of an item of user-linked content into one of the content slots if that item is already in one of the content slots.

In an example, computing device 1400 is configured as a gaming system, e.g., is embodied within a chassis of a gaming system such as a MICROSOFT XBOX. In this example, the modules in computer-readable media 1410 further include a tagging module 1432. Tagging module 1432 is operative while a game is being played and responsive to the user-operable input device 1406 to activate the content module 1426 with the game, an in-game achievement, an in-game award, or an in-game collateral item as the item of user-linked content. Examples of the functions of tagging module 1432 are discussed above with reference to FIGS. 8-10 and any number of blocks 1200, 1206, 1302, 1304, 1306, 1308, 1310, and 1316 in any combination.

In an example, communications interface 1422 includes a transmitter. In this example, the modules in computer-readable media 1410 further include the communications module 1434 configured to provide information regarding the item(s) in the content slots via the transmitter in communications interface 1422. For example, terminal 1106 can included communications module 1434 and can communicate information regarding associations or selections of user-content items to server 1104.

FIG. 15 is an illustrative diagram that shows example components of a computing device 1500, which can represent computing device(s) 102 and/or 104 (e.g., 104(1), 1108. Computing device 1500 can implement profile-retrieving engine 1502, which can represent profile-retrieving module 120, FIG. 1, to retrieve and display user information such as showcase information. Computing device 1500 can, e.g., present visual displays such as those shown in FIGS. 6 and 7.

Computing device 1500 can include or be connected to a display 1504, which can be representative of display 1126. Display 1504 can include an organic light-emitting-diode (OLED) display or other type of visual display, and can have a resolution of 1920×1080 px or other resolution, as discussed above with reference to FIG. 14.

Computing device 1500 can include or be connected to a user-operable input device 1506, which can represent user-operable input device 1128. User-operable input device 1506 can include a keyboard, a keypad, or another input device such as those discussed above with reference to block 1310.

The computing device 1500 may include one or more processing unit(s) 1508, which can represent processing unit(s) 110, 1124. Processing unit(s) 1508 can include, e.g., processing unit types described above such as CPU- or GPGPU-type processing unit(s). In various examples, the computing device 1500 may be a server, a desktop computer, another type of electronic device, or another device type noted above, or a combination of any of those, that is capable of hosting one or more processing unit(s) 1508 to process data.

Processing unit(s) 1508 can be configured to execute modules of a plurality of modules in one or more computer-readable media 1510. Computer-readable media 1510 can represent computer-readable media 112, 1130. Examples of modules in computer-readable media 1510 are discussed below. Computer-readable media 1510 can include an operating system, e.g., operating system 116 (omitted for clarity). In the illustrated example, computer-readable media 1510 includes a data store 1512. In some examples, data store 1512 includes data storage such as discussed above with reference to data store 1412, FIG. 14. In at least one example, the data store may store computer program instructions 1514 (e.g., instructions corresponding to a playable game or other software usable with multi-user system 1102), user data 1516 (e.g., profile information retrieved from server 1104), or any combination thereof. Some or all of the above-referenced data can be stored on one or more memories 1518 on board one or more processing unit(s) 1508, e.g., as described above with reference to memories 1418.

Computing device 1500 can further include one or more input/output (I/O) interface(s) 1520 to allow computing device 1500 to communicate with input/output devices (not shown) such as described above with reference to I/O interface 1420, FIG. 14.

The computing device 1500 can also include a communications interface 1522, which can represent communications interface 122. For example, communications interface 1522 can include a transceiver device such as a NIC to send and receive communications over a network, e.g., as discussed above. As such, the computing device 1500 may have network capabilities. For example, the computing device 1500 may exchange data with other computing devices 102 and/or 104 (e.g., laptops, computers, servers, etc.) via one or more networks 106, such as the Internet.

In at least one example, a system includes the one or more computer-readable media 1510 having thereon a plurality of modules. For example, computer-readable media 1510 of the computing device 1500 may store the modules of the profile-retrieving engine 1502. The processing unit(s) 1508 can be adapted to intercommunicate and to execute modules of the plurality of modules.

The modules stored on computer-readable media 1510 of the profile-retrieving engine 1502 can include one or more modules or APIs, which are illustrated as an identification module 1524, a summary module 1526, a detection module 1528, a detail module 1530, and a retrieval module 1532. The number of modules can vary higher or lower, and modules of various types can be used in various combinations. For example, functionality described associated with the illustrated modules can be combined to be performed by a fewer number of modules or APIs or can be split and performed by a larger number of modules or APIs. For example, the identification module 1524, the summary module 1526, and the detection module 1528 can be combined in a single module (e.g., a shell or API module) that performs at least some of the example functions described below of each of the modules 1524, 1526, 1528. In an example, the summary module 1526 and the retrieval module 1532 can be combined in a single module that performs at least some example functions of the described below of each of the modules 1526, 1532. In various example, the processing unit(s) 1508 can access the module(s) on the computer-readable media 1510 via a bus 1534, which can represent bus 114, FIG. 1. I/O interface 1520 and communications interface 1522 can also communicate with processing unit(s) 1508 via bus 1534.

In various examples, at least some of the modules 1524, 1526, 1528, 1530 are configured to present information via display 1404. The at least some of the modules 1524, 1526, 1528, 1530, in these examples, can include logic or computer program instructions to provide or load pixel values, e.g., as described above with reference to display 1404, FIG. 14.

Still referring to FIG. 15 and referring also to FIG. 7, in an example, the modules include the identification module 1524 configured to present identification information 702 of a user via the display. Various examples of the identification information 702 include identification information 604, e.g., avatar 606, handle 608, location information 610, or biographical information 612 (all FIG. 6).

The summary module 1526 can be configured to present a summary visual representation of a plurality of items of user-linked content via the display. An example of the summary visual representation is showcase display 700 of the item(s) of user-linked content in the user's showcase, including summary visual representations 710, 712, 714 of respective user-linked content items. At least one of the items can include a gameplay video and/or an in-game collateral item. In an example, Alice can use computing device 1500 to access xblsocial034's (“xb's”) profile information. Alice sees showcase display 700, e.g., using terminal 1108. Showcase display 700 includes xb's handle in identification information 702. Summary module 1526 presents summary visual representation(s) 710, 712, 714 of item(s) of user-linked content that xb has added to xb's showcase. In the illustrated example, the user-linked content items corresponding to summary visual representations 710, 714 are gameplay videos, as discussed above with reference to FIG. 7 and indicated by type indicators 716, 720.

In an example, at least one of the items can include a gameplay video and the summary visual representation can include a clip of the gameplay video. The clip can have the same resolution as the gameplay video or reduced resolution, and can include all of the gameplay video or less than all of the gameplay video. The clip can include a montage of multiple, different portions of the gameplay video.

In an example, the plurality of items can include a plurality of gameplay videos. In this example, the summary visual representation can include a montage having, e.g., five seconds of each of the plurality of gameplay videos, or having part or all of the first gameplay video followed by thumbnails or shorter clips of the remaining gameplay videos. In an example, the summary visual representation can include content from fewer than all of the gameplay videos in the content slots.

In various examples, the summary visual representation can be accompanied by audio or can be played without audio, e.g., muted. Muting can permit users to select user-linked content items of interest without requiring the network bandwidth for an audio stream (e.g., 128 kbps). Muting also can permit respective moving-image summary visual representations of multiple user-linked content items to be presented on showcase display 700 concurrently without the user confusion that can arise from concurrent playback of unrelated audio streams. In at least one example, Alice can navigate xb's showcase display 700 and select a user-linked content item of interest to her more readily with audio muted than with multiple audio streams playing back concurrently. In various examples, multiple moving-image summary visual representations are presented concurrently, but audio is played back for only such representation (e.g., that of the first, the leftmost, the most recent, or a randomly-selected item). In various examples, multiple moving-image summary visual representations are presented concurrently, and audio for a plurality of such representations is faded automatically between the representations so that, e.g., each moving image is accompanied by its audio for, e.g., five seconds at a time.

In at least one example, at least one of the items includes a gameplay video and the summary visual representation includes a still thumbnail of the gameplay video. The still thumbnail can be cropped, resized, scaled, resampled, or otherwise modified compared to the corresponding frame of the gameplay video. In at least one example, at least one of the items includes a gameplay video and the summary visual representation includes a collage of part or all of multiple thumbnails from respective, different portions of the gameplay vide. For example, the summary visual representation can included reduced-scale thumbnails from near the beginning of the gameplay video, approximately one-third of the way through the gameplay video, approximately two-thirds of the way through the gameplay video, and near the end of the gameplay video. The four reduced-scale thumbnails can be assembled into a single still, e.g., rectangular in shape, to form the summary visual representation.

In at least one example, the summary module 1526 is further responsive to the detection module 1528 to display an affordance upon pre-selection of the summary visual representation via the user-operable input device 1506. In an example, user-operable input device 1506 includes a pointing control (e.g., a D-pad or mouse) and a selection control (e.g., a button). When a cursor is positioned over summary visual representation 710 or other graphical elements corresponding to content slot 704 using the pointing control, highlight frame 732 can be displayed. Highlight frame 732 can be hidden when the cursor is moved out of the area of content slot 704.

The detection module 1528 can be responsive to the user-operable input device to provide an indication that an item of the plurality of items is selected. For example, the detection module 1528 can detect actuation of a selection control on user-operable input device 1506 and provide the indication in response thereto.

The detail module 1530 can be configured to present information of the selected item of user-linked content via the display in response to the indication from detection module 1528. In an example, in response to user selection of content slot 704 (e.g., in response to the indication while highlight frame 732 is displayed on content slot 704), the full gameplay video associated with summary visual representation 710 can be played back, e.g., in place of summary visual representation 710, in a popup window, or in a new screen or display. The full gameplay video can be accompanied by its audio in at least one example.

In at least one example, the computing device 1500 includes a receiver, e.g., in the communications interface 1522 or the I/O interface 1520. The modules further include the retrieval module 1532 configured to retrieve information regarding the plurality of items via a communications link using the receiver. In this example, the summary module 1526 can be configured to present the summary visual representation using the retrieved information. For example, terminal 1108 can download low-resolution video clips or thumbnails of the user-linked content items in the content slots from server 1104.

### Example Clauses

A: A method, comprising: receiving an indication of an item of user-linked content; displaying a confirmation view including an indication of the available content slot and a representation of the item of user-linked content; receiving a confirmation corresponding to the confirmation view; determining an available content slot of a predetermined number of content slots; and in response to the received confirmation, recording an association between the item of user-linked content and the available content slot in a computer storage medium.

B: A method as paragraph A recites, wherein said receiving a confirmation from the user includes receiving an input via a user-operable input device.

C: A method as either paragraph A or B recites, wherein the item of user-linked content includes at least one of: a gameplay screenshot, a gameplay video of a game, an in-game achievement, an in-game award, a gameplay statistic, an in-game collateral item, a text item, an identifier of a game, or a profile-change notification.

D: A method as any of paragraph A, B, or C recites, wherein said determining an available content slot includes determining that no slot of the predetermined number of content slots is available.

E: A method as paragraph D recites, further including, in response to said determining that no slot is available: displaying a configuration view of the content slots; receiving an indication of one of the content slots to empty; and removing a recorded association between the indicated one of the content slots and a corresponding item of user-linked content, wherein the indicated one of the content slots is the available content slot.

F: A method as paragraph D or E recites, further including, in response to said determining that no slot is available: automatically determining one of the content slots to empty, said determining based at least on a respective recency or a respective rating of items of user-linked content corresponding to the content slots; and removing a recorded association between the determined one of the content slots and a corresponding item of user-linked content, wherein the determined one of the content slots is the available content slot.

G: A method as any of paragraphs A-F recites, wherein said displaying the confirmation view further includes receiving a caption and said recording further includes recording the caption in association with the item of user-linked content in the computer storage medium.

H: A method as any of paragraphs A-G recites, further including, after said receiving the indication: presenting a destination-selection user interface including visual representations of a plurality of sharing destinations, at least one of the sharing destinations being a showcase; and receiving a selection of one of the sharing destinations via the destination-selection user interface; and in response to selection of the showcase, performing the determining, displaying, receiving-confirmation, and recording steps.

I: An apparatus, comprising: a display; a user-operable input device; one or more computer storage media having therein a plurality of modules; and a processing unit configured to execute modules of the plurality of modules comprising: an identification module configured to present identification information of a user via the display; a content module configured to present, via the display, a content view including a visual representation of an item of user-linked content in association with the identification information; a configuration module responsive to selection of the content view via the user-operable input device to cause to be shown on the display a configuration user interface comprising: a predetermined number of content slots; first visual representation(s) of one or more item(s) of user-linked content in respective one(s) of the content slots; and second visual representation(s) of one or more item(s) of user-linked content spaced apart from the content slots; and an insertion module responsive to the user-operable input device during display of the configuration user interface to insert one of the item(s) corresponding to one of the second visual representation(s) into one of the content slots.

J: An apparatus as paragraph I recites, wherein the predetermined number is between three and ten.

K: An apparatus as paragraph I or J recites, wherein the insertion module is configured to prohibit insertion of an item of user-linked content into one of the content slots if that item is already in one of the content slots.

L: An apparatus as any of paragraphs I-K recites, wherein the configuration user interface further includes a sharing control permitting sharing of one or more of the item(s) of user-linked content in the content slots via a communications link.

M: An apparatus as any of paragraphs I-L recites, wherein the configuration user interface includes a rearrangement control permitting rearrangement of item(s) of user-linked content in the content slots and the configuration module is responsive to actuation of the rearrangement control via the user-operable input device to exchange the item(s) in a first one of the content slots and a selected one of the content slots.

N: An apparatus as any of paragraphs I-M recites, further including a transmitter, wherein the modules further comprise a communications module configured to provide information regarding the item(s) in the content slots via the transmitter.

O: An apparatus as any of paragraphs I-N recites, the apparatus configured as a gaming system, the modules further including a tagging module operative while a game is being played and responsive to the user-operable input device to activate the content module with the game, an in-game achievement, an in-game award, or an in-game collateral item as the item of user-linked content.

P: An apparatus as any of paragraphs I-O recites, the configuration user interface further including supplemental information of at least one of the item(s) of user-linked content in the one(s) of the content slots.

Q: An apparatus, comprising: a display; a user-operable input device; one or more computer storage media having therein a plurality of modules; and a processing unit configured to execute modules of the plurality of modules comprising: an identification module configured to present identification information of a user via the display; a summary module configured to present a summary visual representation of a plurality of items of user-linked content via the display, wherein at least one of the items includes a gameplay video and/or an in-game collateral item; a detection module responsive to the user-operable input device to provide an indication that an item of the plurality of items is selected; and a detail module configured to present information of the selected item of user-linked content via the display in response to the indication.

R: An apparatus as paragraph Q recites, further including a receiver, wherein the modules further comprise a retrieval module configured to retrieve information regarding the plurality of items via a communications link using the receiver and the summary module is configured to present the summary visual representation using the retrieved information.

S: An apparatus as paragraph Q or R recites, wherein the summary module is further responsive to the detection module to display an affordance upon pre-selection of the summary visual representation via the user-operable input device.

T: An apparatus as any of paragraphs Q-S recites, wherein at least one of the items includes a gameplay video and the summary visual representation includes a clip of the gameplay video.

U: An apparatus as any of paragraphs Q-T recites, wherein at least one of the items includes a gameplay video and the summary visual representation includes a still thumbnail of the gameplay video.

V: A system comprising: one or more computer-readable media having thereon a plurality of modules; and one or more processing units operably coupled to at least one of the computer-readable media, the processing units adapted to carry out a method as any of paragraphs A-H recites.

W: A computer-readable medium having thereon computer-executable instructions, the computer-executable instructions upon execution configuring a computer to perform operations as any of paragraphs A-H recites.

X: A computer-readable medium having thereon computer-executable instructions, the computer-executable instructions upon execution configuring a computer to perform operations of modules as any of paragraphs I-P recites.

Y: A computer-readable medium having thereon computer-executable instructions, the computer-executable instructions upon execution configuring a computer to perform operations of modules as any of paragraphs Q-U recites.

Z: A system comprising: means for receiving an indication of an item of user-linked content; displaying a confirmation view including an indication of the available content slot and a representation of the item of user-linked content; means for receiving a confirmation corresponding to the confirmation view; means for determining an available content slot of a predetermined number of content slots; and means for, in response to the received confirmation, recording an association between the item of user-linked content and the available content slot in a computer storage medium.

AA: A system as paragraph Z recites, wherein said means for receiving a confirmation from the user includes means for receiving an input via a user-operable input device.

AB: A system as either paragraph Z or AA recites, wherein the item of user-linked content includes at least one of: a gameplay screenshot, a gameplay video of a game, an in-game achievement, an in-game award, a gameplay statistic, an in-game collateral item, a text item, an identifier of a game, or a profile-change notification.

AC: A system as any of paragraphs Z-AB recites, wherein said means for determining an available content slot includes means for determining that no slot of the predetermined number of content slots is available.

AD: A system as paragraph AC recites, further including means for, in response to said determining that no slot is available: displaying a configuration view of the content slots; means for receiving an indication of one of the content slots to empty; and means for removing a recorded association between the indicated one of the content slots and a corresponding item of user-linked content, wherein the indicated one of the content slots is the available content slot.

AE: A system as paragraph AC or AD recites, further including, means for in response to said determining that no slot is available: automatically determining one of the content slots to empty, said determining based at least on a respective recency or a respective rating of items of user-linked content corresponding to the content slots; and means for removing a recorded association between the determined one of the content slots and a corresponding item of user-linked content, wherein the determined one of the content slots is the available content slot.

AF: A system as any of paragraphs Z-AE recites, wherein said means for displaying the confirmation view further includes means for receiving a caption and said means for recording further includes means for recording the caption in association with the item of user-linked content in the computer storage medium.

AG: A system as any of paragraphs Z-AF recites, further including means for, after said receiving the indication: presenting a destination-selection user interface including visual representations of a plurality of sharing destinations, at least one of the sharing destinations being a showcase; and means for receiving a selection of one of the sharing destinations via the destination-selection user interface; and means for in response to selection of the showcase, performing the determining, displaying, receiving-confirmation, and recording steps.

### CONCLUSION

Although the techniques have been described in language specific to structural features and/or methodological acts, it is to be understood that the appended claims are not necessarily limited to the features or acts described. Rather, the features and acts are described as examples of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) 102, 104, 106, 1104, 1106, 1108, 1112, 1116, 1124, 1400, 1408, 1500, and/or 1508, such as or including one or more internal or external CPUs or GPUs, and/or one or hardware logic devices such as FPGAs, DSPs, or other types discussed above.

All of the methods and processes described above may be embodied in, and fully automated via, software code modules executed by one or more general purpose computers or processors. The code modules may be stored in any type of computer-readable storage medium or other computer storage device. Some or all of the methods may also or alternatively be wholly or partly embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof. The word “or” is used in this disclosure in a non-exclusive sense, unless otherwise explicitly noted.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternative implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method, comprising:
receiving an indication of an item of user-linked content;
displaying a confirmation view including an indication of the available content slot and a representation of the item of user-linked content;
receiving a confirmation corresponding to the confirmation view;
determining an available content slot of a predetermined number of content slots; and
in response to the received confirmation, recording an association between the item of user-linked content and the available content slot in a computer storage medium.

2. The method as claim 1 recites, wherein said receiving a confirmation from the user includes receiving an input via a user-operable input device.

3. The method as claim 1 recites, wherein the item of user-linked content includes at least one of: a gameplay screenshot, a gameplay video of a game, an in-game achievement, an in-game award, a gameplay statistic, an in-game collateral item, a text item, an identifier of a game, or a profile-change notification.

4. The method as claim 1 recites, wherein said determining an available content slot includes determining that no slot of the predetermined number of content slots is available.

5. The method as claim 4 recites, further including, in response to said determining that no slot is available:
displaying a configuration view of the content slots;
receiving an indication of one of the content slots to empty; and
removing a recorded association between the indicated one of the content slots and a corresponding item of user-linked content, wherein the indicated one of the content slots is the available content slot.

6. The method as claim 4 recites, further including, in response to said determining that no slot is available:
automatically determining one of the content slots to empty, said determining based at least on a respective recency or a respective rating of items of user-linked content corresponding to the content slots; and
removing a recorded association between the determined one of the content slots and a corresponding item of user-linked content, wherein the determined one of the content slots is the available content slot.

7. The method as claim 1 recites, wherein said displaying the confirmation view further includes receiving a caption and said recording further includes recording the caption in association with the item of user-linked content in the computer storage medium.

8. The method as claim 1 recites, further including, after said receiving the indication:
presenting a destination-selection user interface including visual representations of a plurality of sharing destinations, at least one of the sharing destinations being a showcase; and
receiving a selection of one of the sharing destinations via the destination-selection user interface; and
in response to selection of the showcase, performing the determining, displaying, receiving-confirmation, and recording steps.

9. An apparatus, comprising:
a display;
a user-operable input device;
one or more computer storage media having therein a plurality of modules; and
a processing unit configured to execute modules of the plurality of modules comprising:
an identification module configured to present identification information of a user via the display;
a content module configured to present, via the display, a content view including a visual representation of an item of user-linked content in association with the identification information;
a configuration module responsive to selection of the content view via the user-operable input device to cause to be shown on the display a configuration user interface comprising:
a predetermined number of content slots;
first visual representation(s) of one or more item(s) of user-linked content in respective one(s) of the content slots; and
second visual representation(s) of one or more item(s) of user-linked content spaced apart from the content slots; and
an insertion module responsive to the user-operable input device during display of the configuration user interface to insert one of the item(s) corresponding to one of the second visual representation(s) into one of the content slots.

10. The apparatus as claim 9 recites, wherein the predetermined number is between three and ten.

11. The apparatus as claim 9 recites, wherein the insertion module is configured to prohibit insertion of an item of user-linked content into one of the content slots if that item is already in one of the content slots.

12. The apparatus as claim 9 recites, wherein the configuration user interface further includes a sharing control permitting sharing of one or more of the item(s) of user-linked content in the content slots via a communications link.

13. The apparatus as claim 9 recites, wherein the configuration user interface includes a rearrangement control permitting rearrangement of item(s) of user-linked content in the content slots and the configuration module is responsive to actuation of the rearrangement control via the user-operable input device to exchange the item(s) in a first one of the content slots and a selected one of the content slots.

14. The apparatus as claim 9 recites, further including a transmitter, wherein the modules further comprise a communications module configured to provide information regarding the item(s) in the content slots via the transmitter.

15. The apparatus as claim 9 recites, the apparatus configured as a gaming system, the modules further including a tagging module operative while a game is being played and responsive to the user-operable input device to activate the content module with the game, an in-game achievement, an in-game award, or an in-game collateral item as the item of user-linked content.

16. An apparatus, comprising:
a display;
a user-operable input device;
one or more computer storage media having therein a plurality of modules; and
a processing unit configured to execute modules of the plurality of modules comprising:
an identification module configured to present identification information of a user via the display;
a summary module configured to present a summary visual representation of a plurality of items of user-linked content via the display, wherein at least one of the items includes a gameplay video and/or an in-game collateral item;
a detection module responsive to the user-operable input device to provide an indication that an item of the plurality of items is selected; and
a detail module configured to present information of the selected item of user-linked content via the display in response to the indication.

17. The apparatus as claim 16 recites, further including a receiver, wherein the modules further comprise a retrieval module configured to retrieve information regarding the plurality of items via a communications link using the receiver and the summary module is configured to present the summary visual representation using the retrieved information.

18. The apparatus as claim 16 recites, wherein the summary module is further responsive to the detection module to display an affordance upon pre-selection of the summary visual representation via the user-operable input device.

19. The apparatus as claim 16 recites, wherein at least one of the items includes a gameplay video and the summary visual representation includes a clip of the gameplay video.

20. The apparatus as claim 16 recites, wherein at least one of the items includes a gameplay video and the summary visual representation includes a still thumbnail of the gameplay video.
